(19) United States
(12) Patent Application Publication
(10) Pub. No.: US 2023/0025259 A1
(43) Pub. Date: Jan. 26, 2023

(54) METHOD AND APPARATUS FOR SIDELINK RESOURCE ALLOCATION IN UNLICENSED SPECTRUM

(71) Applicant: Samsung Electronics Co., Ltd., Suwon-si (KR)

(72) Inventors: Emad N. Farag, Flanders, NJ (US); Hongbo Si, Plano, TX (US)

(21) Appl. No.: 17/812,704

(22) Filed: Jul. 14, 2022

Related U.S. Application Data
(60) Provisional application No. 63/224,742, filed on Jul. 22, 2021.

(51) Int. Cl. H04W 72/12; H04W 74/08

(52) U.S. Cl. CPC H04W 72/1278; H04W 74/0808; H04W 92/18

(57) ABSTRACT

Methods and apparatuses for sidelink (SL) resource allocation in unlicensed spectrum in a wireless communication system. A method of operating a user equipment (UE) includes performing sensing on a SL interface; determining, based on the sensing, a set of available SL resources within a SL resource pool; and selecting a slot within the SL resource pool. The method further includes performing a listen-before-talk (LBT) channel access procedure before the slot; determining a presence of available SL resources from the set of available SL resources within the slot; and transmitting, based on the LBT channel access procedure being successful and the presence being determined, in an available SL resource from the available SL resources within the slot.

### CROSS-REFERENCE TO RELATED APPLICATIONS AND CLAIM OF PRIORITY

The present application claims priority to U.S. Provisional Patent Application No. 63/224,742, filed on Jul. 22, 2021. The content of the above-identified patent document is incorporated herein by reference.

### TECHNICAL FIELD

The present disclosure relates generally to wireless communication systems and, more specifically, the present disclosure relates to a sidelink (SL) resource allocation in unlicensed spectrum in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a SL resource allocation in unlicensed spectrum in a wireless communication system.

In one embodiment, a user equipment (UE) in a wireless communication system is provided. The UE includes a processor configured to perform sensing on a SL interface, determine, based on the sensing, a set of available SL resources within a SL resource pool, and select a slot within the SL resource pool. The UE further includes a transceiver operably coupled to the processor. The transceiver is configured to perform a listen-before-talk (LBT) channel access procedure before the slot. The processor is further configured to determine a presence of available SL resources from the set of available SL resources within the slot. The transceiver is further configured to transmit, when the LBT channel access procedure is successful and the presence is determined, in an available SL resource from the available SL resources within the slot.

In another embodiment a method of operating a UE in a wireless communication system is provided. The method includes performing sensing on a SL interface, determining, based on the sensing, a set of available SL resources within a SL resource pool, and selecting a slot within the SL resource pool. The method further includes performing a LBT channel access procedure before the slot; determining a presence of available SL resources from the set of available SL resources within the slot; and transmitting, based on the LBT channel access procedure being successful and the presence being determined, in an available SL resource from the available SL resources within the slot.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate an example of wireless transmit and receive paths according to various embodiments of the present disclosure;

FIG. 6 illustrates an example of timing of the sensing window, resource selection window and a slot n according to various embodiments of the present disclosure;

FIG. 7 illustrates a flowchart of UE method for combined SL sensing and LBT channel access operation according to various embodiments of the present disclosure;

FIG. 8 illustrates another flowchart of UE method for combined SL sensing and LBT channel access operation according to various embodiments of the present disclosure;

FIG. 9 illustrates yet another flowchart of UE method for combined SL sensing and LBT channel access operation according to various embodiments of the present disclosure;

FIG. 10 illustrates yet another flowchart of UE method for combined SL sensing and LBT channel access operation according to various embodiments of the present disclosure;

FIG. 11 illustrates yet another flowchart of UE method for combined SL sensing and LBT channel access operation according to various embodiments of the present disclosure;

FIG. 12 illustrates yet another flowchart of UE method for combined SL sensing and LBT channel access operation according to various embodiments of the present disclosure;

FIG. 13 illustrates an example of slot structure according to various embodiments of the present disclosure;

FIG. 14 illustrates another example of slot structure according to various embodiments of the present disclosure;

FIG. 15 illustrates yet another example of slot structure according to various embodiments of the present disclosure;

FIG. 16 illustrates yet another example of slot structure according to various embodiments of the present disclosure;

FIG. 17 illustrates yet another example of slot structure according to various embodiments of the present disclosure;

FIG. 18 illustrates yet another example of slot structure according to various embodiments of the present disclosure;

FIG. 19 illustrates yet another flowchart of UE method for combined SL sensing and LBT channel access operation according to various embodiments of the present disclosure; and

FIG. 20 illustrates yet another flowchart of UE method for combined SL sensing and LBT channel access operation according to various embodiments of the present disclosure.

### DETAILED DESCRIPTION

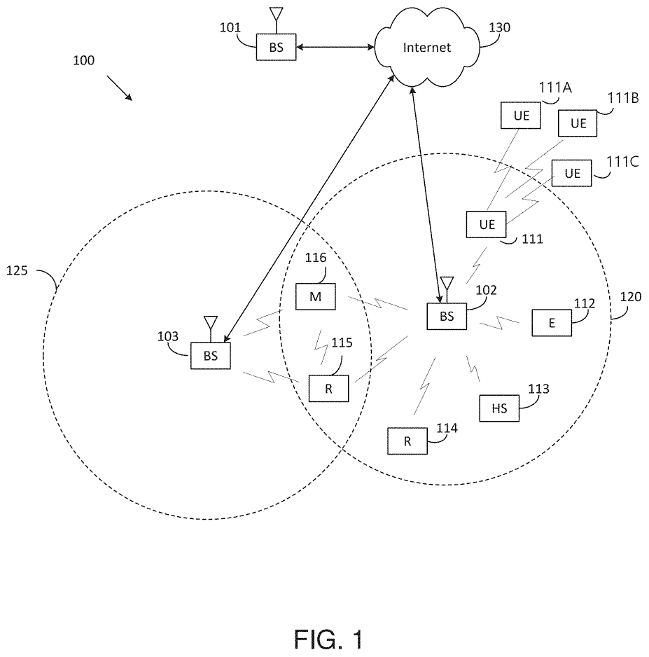

FIG. 1 through FIG. 20, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v.17.20, “Physical channels and modulation”; 3GPP TS 38.212 v.17.2.0, “Multiplexing and channel coding”; 3GPP TS 38.213 v17.2.0, “NR; Physical Layer Procedures for Control”; 3GPP TS 38.214: v.17.2.0, “Physical layer procedures for data”; 3GPP TS 38.321 v17.0.0, “Medium Access Control (MAC) protocol specification”; 3GPP TS 38.331 v.17.0.1, “Radio Resource Control (RRC) protocol specification”; and 3GPP TS 36.213 v17.2.0, “Evolved Universal Terrestrial Radio Access (E-UTRA); Physical layer.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In various embodiments, a UE 116 may communicate with another UE 115 via a SL. For example, both UEs 115-116 can be within network coverage (of the same or different base stations). In another example, the UE 116 may be within network coverage and the other UE may be outside network coverage (e.g., UEs 111A-111C). In some embodiments, the UEs 111A-111C may use a device to device (D2D) interface called PC5 (e.g., also known as sidelink at the physical layer) for communication. In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In yet another example, UEs 111A to 111C can communicate with another of the UEs 111A to 111C.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a SL resource allocation in unlicensed spectrum in a wireless communication system. In certain embodiments, and one or more of the gNBs 101-103 includes circuitry, programing, or a combination thereof, for a SL resource allocation in unlicensed spectrum in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs (e.g., via a Uu interface or air interface, which is an interface between a UE and 5G radio access network (RAN)) and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UE 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

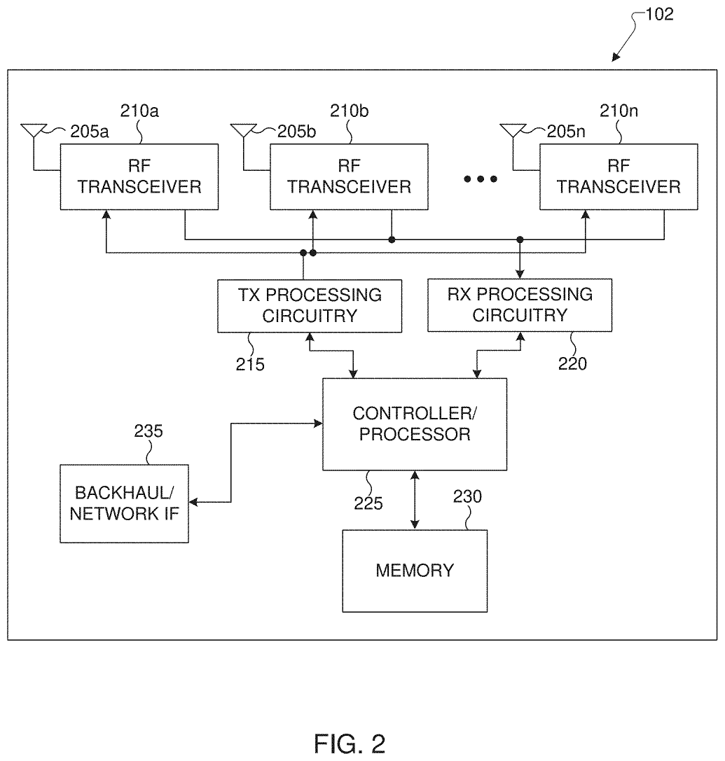

FIG. 2 illustrates an example of gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this present disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink channel signals and the transmission of downlink channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support a SL resource allocation in unlicensed spectrum in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

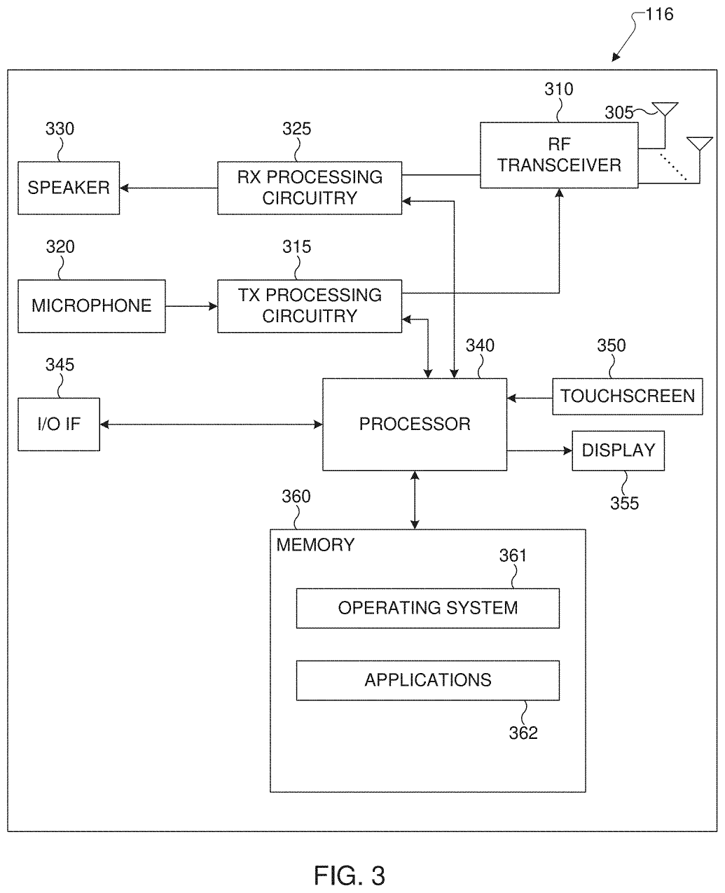

FIG. 3 illustrates an example of UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this present disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100 or by other UEs (e.g., one or more of UEs 111-115) on a SL channel. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of downlink and/or SL channels and/or signals and the transmission of uplink and/or SL channels and/or signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a SL resource allocation in unlicensed spectrum in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points and a SL that refers to transmissions from one or more UEs to one or more UEs.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 30 KHz or 15 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DMRS is transmitted only in the BW of a respective PDCCH or PDSCH and a UE can use the DMRS to demodulate data or control information.

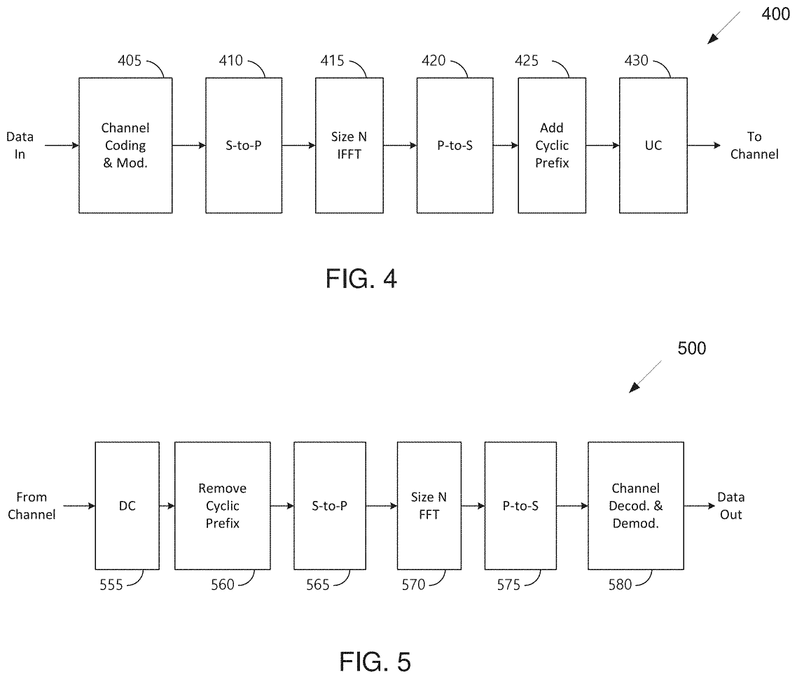

FIG. 4 and FIG. 5 illustrate examples of wireless transmit and receive paths according to this present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support SL communications. In some embodiments, the receive path 500 is configured to support SL sensing and SL measurements in SL communication and listen-before-talk (LBT) channel access operation on unlicensed spectrum as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. A transmitted RF signal from a first UE arrives at a second UE after passing through the wireless channel, and reverse operations to those at the first UE are performed at the second UE.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the SL to another UE and may implement the receive path 500 for receiving in the downlink from the gNBs 101-103 and/or receiving in the SL from another UE.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz.

An RB in one symbol of a slot is referred to as physical RB (PRB) and includes a number of resource elements (REs). A slot can be either full DL slot, or full UL slot, or hybrid slot similar to a special subframe in time division duplex (TDD) systems as defined in 3GPP standard specification. In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information, physical SL control channels (PSCCHs) conveying SL control information (SCI) for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, and physical SL broadcast channel (PSBCH) conveying system information to assist in SL synchronization.

SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a DCI format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a UE can be (pre-)configured one of two options for reporting of HARQ-ACK information by the UE: (1) HARQ-ACK reporting option (1): A UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB; (2) HARQ-ACK reporting option (2): A UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A SL resource pool includes a set/pool of slots and a set/pool of RBs used for SL transmission and SL reception. A set of slots which can belong to a SL resource pool can be denoted by {t₀^{SL}, t₁^{SL}, t₂^{SL}, . . . }. A set of slots which belong to a resource pool can be denoted by {t′₀^{SL}, t′₁^{SL}, t′_{T′}_{_{MAX}}₋₁^{SL}} and can be configured, for example, at least using a bitmap. Where, T′_{MAX} is the number of SL slots in a resource pool within 1024 frames, a frame has a duration of 10 ms. Within each slot t′_{y}^{SL} of a SL resource pool, there are N_{subCH} contiguous sub channels in the frequency domain for SL transmission, where N_{subCH} is provided by a higher-layer parameter. Subchannel m, where m is between 0 and N_{subCH}−1, is given by a set of n_{subCHsize} PRBs, given by n_{PRB}=n_{subCHstart}+m·n_{subCHsize}+j, where j=0, 1, . . . , n_{subCHsize}−1, n_{subCHstart} and n_{subCHsize} are provided by higher layer parameters.

The slots of a SL resource pool are determined as follows.

In one example of determination, let a set of slots that may belong to a resource be denoted by {t₀^{SL}, t₁^{SL}, t₂^{SL}, . . . , t_{T}_{_{MAX}}₋₁^{SL}}, where 0≤tᵢ^{SL}<10240×2^{μ}, and 0≤i<Tₘₐₓ, μ is the sub-carrier spacing configuration. μ=0 for a 15 kHz sub-carrier spacing. μ=1 for a 30 kHz sub-carrier spacing. μ=2 for a 60 kHz sub-carrier spacing. μ=3 for a 120 kHz sub-carrier spacing. The slot index is relative to slot #0 of SFN #0 of the serving cell, or DFN #0. The set of slots includes all slots except:
N_{S-SSB} slots that are configured for SL SS/PBCH Block (S-SSB);
N_{nonSL} slots where at least one SL symbols is not semi-statically configured as UL symbol by higher layer parameter tdd-UL-DL-ConfigurationCommon or sl-TDD-Configurauion. In a SL slot, OFDM symbols Y-th, (Y+1)-th, (Y+X−1)-th are SL symbols, where Y is determined by the higher layer parameter sl-StartSymbol and X is determined by higher layer parameter sl-LengthSymbols; and
N_{reserved} reserved slots. Reserved slots are determined such that the slots in the set {t₀^{SL}, t₁^{SL}, t₂^{SL}, . . . , t_{T}_{_{MAX}}₋₁^{SL}} is a multiple of the bitmap length (L_{bitmap}), where the bitmap (b₀, b₁, . . . , b_{bitmap-1}) is configured by higher layers.

The reserved slots are determined as follows:
Let {l₀, l₁, l₂_{^{μ}}_{×10240-N}_{_{S-SSB}}_{-N}_{_{nonSL}}₋₁} be the set of slots in range 0 . . . 2^{μ}×10240−1, excluding S-SSB slots and non-SL slots. The slots are arranged in ascending order of the slot index;
The number of reserved slots is given by: N_{reserved}=(2^{μ}×10240−N_{S-SSB}−N_{nonSL}) mod L_{bitmap}; and
The reserved slots lᵣ are given by:

$$r = ⌊ \frac{m \cdot ( {2}^{μ} \times 10240 - {N}_{S - SSB} - {N}_{n o n S L} )}{{N}_{reserved}} ⌋ ,$$

where, m=0, 1, . . . , N_{reserved}.

Tₘₐₓ is given by: Tₘₐₓ=2^{μ}×10240−N_{S-SSB}−N_{nonSL}−N_{reserved}−1.

The slots are arranged in ascending order of slot index.

The set of slots belonging to the SL resource pool, {t′₀^{SL}, t′₁^{SL}, t′₂^{SL}, . . . , t′_{T′}_{_{MAX}}₋₁^{SL}}, are determined as follows:
Each resource pool has a corresponding bitmap (b₀, b₁, . . . , b_{L}_{_{bitmap}}₋₁) of length L_{bitmap};
A slot tₖ^{SL} belongs to the resource pool if b_{k mod L}_{_{bitmap}}=1; and
The remaining slots are indexed successively staring from 0, 1, . . . T′_{MAX}−1. Where, T′_{MAX} is the number of remaining slots in the set.

Slots can be numbered (indexed) as physical slots or logical slots, wherein physical slots, include all slots numbered sequential, while logical slots include only slots that belong to a SL resource pool as described above numbered sequentially. The conversion from a physical duration, Pᵣₛᵥₚ, in milli-second to a logical slots, P′ᵣₛᵥₚ, is given by

$${P}_{rsvp}^{′} = ⌈ \frac{{T}_{max}^{′}}{10240 ms} \times {P}_{rsvp} ⌉ .$$

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t′_{y}^{SL}. T₁ is determined by the UE such that, 0≤T₁≤T_{proc,1}^{SL}, where T_{proc,1}^{SL} is a PSSCH processing time for example as defined in TS 38.214 Table 8.1.4-2. T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is a configured by higher layers and depends on the priority of the SL transmission.

The resource (re-)selection is a two-step procedure: (1) the first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE measures a SL RSRP that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH DMRS or PSSCH DMRS. Sensing is performed over slots where the UE doesn't transmit SL. The resources excluded are based on reserved transmissions or semi-persistent transmissions that can collide with any of reserved or semi-persistent transmissions. The identified candidate resources after resource exclusion are provided to higher layers. (2) The second step (e.g., performed in the higher layers) is to select or re-select a resource from the identified candidate resources for PSSCH/PSCCH transmission.

During the first step of the resource (re-)selection procedure, a UE can monitor slots in a sensing window [n−T₀, n−T_{proc,0}^{SL}), where the UE monitors slots belonging to a corresponding

SL resource pool that are not used for the UE' s own transmission. For example, T_{proc,0}^{SL} is the sensing processing latency time, for example as defined in 3GPP standard specification, TS 38.214 Table 8.1.4-1. To determine a candidate single-slot resource set to report to higher layers, a UE excludes (e.g., resource exclusion) from the set of available single-slot resources for SL transmission within a resource pool and within a resource selection window, the according to following examples.

In one example, the UE may exclude single slot resource R_{x,y}, such that for any slot t′ₘ^{SL} not monitored within the sensing window with a hypothetical received SCI Format 1-A, with a “Resource reservation period” set to any periodicity value allowed by a higher layer parameter sl-ResourceReservePeriodList, and indicating all sub-channels of the resource pool in this slot, satisfies condition 2.2. below.

In one example, the UE may exclude single slot resource R_{x,y}, such that for any received SCI within the sensing window.

In such example, the associated L1-RSRP measurement is above a (pre-)configured SL-RSRP threshold, where the SL-RSRP threshold depends on the priority indicated in the received SCI and that of the SL transmission for which resources are being selected.

In such example (Condition 2.2), the received SCI in slot t′ₘ^{SL}, or if “Resource reservation field” is present in the received SCI the same SCI is assumed to be received in slot t′_{m+q×P′}_{_{rsvp,Rx}}^{SL}, indicates a set of resource blocks that overlaps R_{x,y+j×P′}_{_{rsvp,Tx}}, where : (1) q=1,2, . . . , Q, where: (i) if P_{rsvp_RX}≤T_{scal} and

$${n}^{′} - m < {P}_{rsvp\_Rx}^{′} \to Q = ⌈ \frac{{T}_{s c a l}}{{P}_{rsvp\_RX}} ⌉ .$$

T_{scal} is T₂ in units of milli-seconds; (ii) else Q=1; and (iii) if n belongs to (t′₀^{SL}, t′₁^{SL}, . . . , t′_{T′}_{_{max−1}}^{SL}), n′=n, else n′ is the first slot after slot n belonging to set (t′₀^{SL}, t′₁^{SL}, . . . , t′_{T′}_{_{max−1}}^{SL}); (2) j=0, 1, . . . , Cᵣₑₛₑₗ−1; (3) P_{rsvp_RX} is the indicated resource reservation period in the received SCI in physical slots, and P′_{rsvp_Rx} is that value converted to logical slots; and (4) P′_{rsvp_Tx} is the resource reservation period of the SL transmissions for which resources are being reserved in logical slots.

In such example, if the candidate resources are less than a (pre-)configured percentage given by higher layer parameter sl_TxPrecentageList(prio_{TX}) that depends on the priority of the SL transmission prio_{TX}, such as 20%, of the total available resources within the resource selection window, the (pre-)configured SL-RSRP thresholds are increased by a predetermined amount, such as 3 dB.

NR SL introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃.

The re-evaluation check includes: (1) performing the first step of the SL resource selection procedure as defined in the 3GPP specifications [i.e., 38.214 clause 8.1.4], which involves identifying a candidate (available) SL resource set in a resource selection window as previously described.

If the pre-selected resource is available in the candidate SL resource set, the resource is used/signaled for SL transmission.

Else, the pre-selected resource is not available in the candidate SL resource set, a new SL resource is re-selected from the candidate SL resource set.

Pre-emption check occurs when a UE checks the availability of pre-selected SL resources that have been previously signaled and reserved in an SCI Format, and if needed re-selects new SL resources. For a pre-selected and reserved resource to be signaled in slot m, the UE performs a pre-emption check at least in slot m−T₃.

The pre-emption check includes: (1) performing the first step of the SL resource selection procedure as defined in the 3GPP specifications [i.e., 38.214 clause 8.1.4], which involves identifying candidate (available) SL resource set in a resource selection window as previously described; (2) if the pre-selected and reserved resource is available in the candidate SL resource set, the resource is used/signaled for SL transmission; and (3) Else, the pre-selected and reserved resource is NOT available in the candidate SL resource set. The resource is excluded from the candidate resource set due to an SCI, associated with a priority value P_{RX}, having an RSRP exceeding a threshold. Let the priority value of the SL resource being checked for pre-emption be P_{TX}.

If the priority value P_{RX} is less than a higher-layer configured threshold and the priority value P_{RX} is less than the priority value P_{TX}. The pre-selected and reserved SL resource is pre-empted. A new SL resource is re-selected from the candidate SL resource set. Note that, a lower priority value indicates traffic of higher priority.

Else, the resource is used/signaled for SL transmission.

As described above, the monitoring procedure for resource (re)selection during the sensing window requires reception and decoding of a SCI format during the sensing window as well as measuring the SL RSRP. This reception and decoding process and measuring the SL RSRP increases a processing complexity and power consumption of a UE for SL communication and requires the UE to have receive circuitry on the SL for sensing even if the UE only transmits and does not receive on the SL. The aforementioned sensing procedure is referred to as full sensing.

3GPP Release 16 is the first NR release to include SL through work item “5G V2X with NR sidelink”, the mechanisms introduced focused mainly on vehicle-to-everything (V2X), and can be used for public safety when the service requirement can be met. Release 17 extends SL support to more use cases through work item “NR Sidelink enhancement” (RP-201385). The objectives of Rel-17 SL include: (1) Resource allocation enhancements that reduce power consumption. (2) enhanced reliability and reduced latency.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic. The UE monitors slots at t′_{y-k×P}_{ᵣₑₛₑᵣᵥₑ}^{SL}, where t′_{y}^{SL} is a slot of the Y selected candidate slots. The periodicity value for sensing for PBPS, i.e. Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList, if not configured, Pᵣₑₛₑᵣᵥₑ includes all periodicities in sl-ResourceReservePeriodList. The UE monitors k sensing occasions determined by additionalPeriodicSensingOccasion, as previously described, and not earlier than n−T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensingOccasion is not (pre-)configured, and additionally includes the value of k corresponding to the last periodic sensing occasion prior to the most recent one if additionalPeriodicSensingOccasion is (pre-)configured. t′_{y0}^{SL} is the first slot of the selected Y candidate slots of PBPS. When a UE performs CPS, the UE selects a set of Y′ slots (Y′≥Y′ₘᵢₙ) within a resource selection window corresponding to CPS, where Y′ₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}−(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over SL to aid the resource allocation mode 2 (re-)selection procedure. UE-A provides information to UE-B, and UE-B uses the provided information for its resource allocation mode 2 (re-)selection procedure. IUC is designed to address issues with distributed resource allocation such as: (1) Hidden node problem, where a UE-B is transmitting to a UE-A and UE-B can't sense or detect transmissions from a UE-C that interfere with its transmission to a UE-A, (2) Exposed node problem, where a UE-B is transmitting to a UE-A, and UE-B senses or detects transmissions from a UE-C and avoids the resources used or reserved by UE-C, but UE-C doesn't cause interference at UE-A, (3) Persistent collision problem, and (4) Half-duplex problem, where UE-B is transmitting to a UE-A in the same slot that UE-A is transmitting in, UE-A will miss the transmission from UE-B as UE-A cannot receive and transmit in the same slot.

There are two schemes for inter-UE co-ordination:

In one example, in scheme 1, a UE-A can provide to another UE-B indications of resources that are preferred to be included in UE-B's (re-)selected resources, or non-preferred resources to be excluded for UE-B's (re-)selected resources. When given preferred resources, UE-B may use only those resources for its resource (re-)selection, or UE-B may combine them with resources identified by its own sensing procedure, e.g., by finding the intersection of the two sets of resources, for its resource (re-)selection. When given non-preferred resources, UE-B may exclude these resources from resources identified by its own sensing procedure for its resource (re-)selection.

Transmissions of co-ordination information (e.g., IUC messages) sent by UE-A to UE-B, and co-ordination information requests (e.g., IUC requests) sent by UE-A to UE-B, are sent in a MAC-CE message and may also, if supported by the UEs, be sent in a 2^{nd}-stage SCI Format (SCI Format 2-C). The benefit of using the 2nd stage SCI is to reduce latency. IUC messages from UE-A to UE-B can be sent standalone, or can be combined with other SL data. Coordination information (IUC messages) can be in response to a request from UE-B, or due to a condition at UE-A. An IUC request is unicast from UE-B to UE-A, in response UE-A sends an IUC message in unicast mode to UE-B. An IUC message transmitted as a result of an internal condition at UE-A can be unicast to UE-B, when the IUC message includes preferred resources, or can be unicast, groupcast or broadcast to UE-B when the IUC message includes non-preferred resources. UE-A can determine preferred or non-preferred resources for UE-B based on its own sensing taking into account the SL-RSRP measurement of the sensed data and the priority of the sensed data, i.e., the priority field of the decoded PSCCH during sensing as well as the priority the traffic transmitted by UE-B in case of request-based IUC or a configured priority in case of condition-based IUC. Non-preferred resource to UE-B can also be determined to avoid the half-duplex problem, where, UE-A can't receive data from a UE-B in the same slot UE-A is transmitting.

In another example, in scheme 2, a UE-A can provide to another UE-B an indication that resources reserved for UE-B's transmission, whether or not UE-A is the destination UE of these resources, are subject to conflict with a transmission from another UE. UE-A determines the conflicting resources based on the priority and RSRP of the transmissions involved in the conflict. UE-A can also determine a presence of a conflict due to the half-duplex problem, where UE-A can't receive a reserved resource from UE-B at the same time UE-A is transmitting. When UE-B receives a conflict indication for a reserved resource, UE-B can re-select new resources to replace them.

The conflict information from UE-A is sent in a PSFCH channel separately (pre-) configured from the PSFCH of the SL-HARQ operation. The timing of the PSFCH channel carrying conflict information can be based on the SCI indicating reserved resource, or based on the reserved resource.

In both schemes, UE-A can identify resources according to a number of conditions which are based on the SL-RSRP of the resources in question as a function of the traffic priority, and/or whether UE-A would be unable to receive a transmission from UE-B, due to performing its own transmission, i.e. a half-duplex problem. The purpose of this exchange of information is to give UE-B information about resource occupancy acquired by UE-A which UE-B might not be able to determine on its own due to hidden nodes, exposed nodes, persistent collisions, etc.

Release 18 considers further evolution of the NR SL air interface for operation in unlicensed bands, beam-based operation in FR2, SL carrier aggregation and co-channel co-existence between LTE SL and NR SL.

In Rel-16, procedures for operation of NR Uu interface over unlicensed spectrum targeting frequencies to around 7 GHz are developed. In unlicensed spectrum the NR radio access technology (RAT) is shared with other Radio Access Technologies such as WiFi. To ensure fair access to the spectrum by the different technologies' procedures are in place for channel access. In NR when operating over unlicensed spectrum, the intended transmitters listen to the air interface to ensure that no other user is accessing the channel before the transmitters starts to transmit. This procedure is known as listen-before-talk (LBT) channel access procedure.

The LBT channel access procedure is a procedure based on sensing that evaluates the availability of a channel for performing transmissions. The basic unit for sensing is a sensing slot with a duration Tₛₗ=9 μs. The sensing slot duration Tₛₗ is considered to be idle if an eNB/gNB or a UE senses the channel during the sensing slot duration, and determines that the detected power for at least 4 μs within the sensing slot duration is less than energy detection threshold X_{Thresh}. Otherwise, the sensing slot duration Tₛₗ is considered to be busy.

There are two types of LBT channel access procedures: (1) Type 1 channel access procedure (e.g., TS 37.213 clause 4.1.1 and TS 37.213 clause 4.2.1.1). (2) Type 2 channel access procedure (e.g., TS 37.213 clause 4.1.2 and TS 37.213 clause 4.2.1.2). Type 2 channel access procedure further includes (1) Type 2A channel access procedure (e.g., TS 37.213 clause 4.1.2.1 and TS 37.213 clause 4.2.1.2.1). (2) Type 2B channel access procedure (e.g., TS 37.213 clause 4.1.2.2 and TS 37.213 clause 4.2.1.2.2). (3) Type 2C channel access procedure (e.g., TS 37.213 clause 4.1.2.3 and TS 37.213 clause 4.2.1.2.3). The Type 2A and/or Type 2B and/or Type 2C can be referred to as short LBT channel access procedure.

One of the features of operation in unlicensed spectrum is channel occupancy time (COT) sharing. In one example, the gNB initializes a COT and shares it with its UEs. The gNB is the Initiating Device, the UEs of the gNB are the Responding Devices. The COT can have one or multiple switching points between DL and UL. If the DL-UL gap is less than 16 usec, the UE can transmit for up to 584 usec without sensing, if the DL-UL gap is 16 usec, the UE can transmit after 16 usec of sensing, if the DL-UL gap is 25 usec, the UE can transmit after 25 usec of sensing. If the UL-DL gap is less than 16 usec, the gNB can transmit for up to 584 usec without sensing, if the UL-DL gap is 16 usec, the gNB can transmit after 16 usec of sensing, if the UL-DL gap is 25 usec, the gNB can transmit after 25 usec of sensing.

In another example, the UE initializes a COT and shares it with its gNB. The UE is the Initiating Device, the gNB is the Responding Devices. The COT can have one switching point from UL to DL. If the UL-DL gap is less than 16 usec, the gNB can transmit for up to 584 usec without sensing, if the UL-DL gap is 16 usec, the gNB can transmit after 16 usec of sensing, if the UL-DL gap is 25 usec, the gNB can transmit after 25 usec of sensing.

In Rel-16 and Rel-17, SL operates over licensed spectrum and intelligent transport service (ITS) spectrum. To support higher data rates expected for new SL applications, which exceeds 1 Gbps it is expected that new spectrum may be used. Given the scarcity of licensed and ITS spectrum, it seems that unlicensed spectrum is a promising option for supporting SL with higher data rates.

In this disclosure, an apparatus and methods for supporting SL operation in unlicensed spectrum is provided.

3GPP Release 16 is the first NR release to include SL through work item “5G V2X with NR sidelink,” the mechanisms introduced focused mainly on vehicle-to-everything (V2X) and can be used for public safety when the service requirement can be met. Release 17 extends SL support to more use cases through work item “NR Sidelink enhancement” targeting low power operation and enhanced reliability and reduced latency. In Release 18 it is expected that SL may be expanded to support new applications that require support of high data rates. Using more bandwidth is one approach to increase the data rate. Rel-16 and Rel-17 support NR SL operation over licensed and ITS spectrum, given the scarcity of licensed and ITS spectrum, unlicensed spectrum seems to be a good spectrum type to use for SL in Rel-18 to increase the SL spectrum. Unlicensed spectrum is shared with other radio access technologies (e.g., WiFi), and regulations require channel access procedures that ensure fair sharing of this spectrum. In this disclosures, an apparatus and methods for SL resource allocation in unlicensed spectrum is provided.

The present disclosure relates to a 5G/NR communication system.

This disclosure considers SL resource allocation in unlicensed spectrum: (1) combining SL sensing of pervious slots and LBT channel access procedure to determine availability of resource for SL transmission; (2) extension of SL transmission during guard period for continuity of COT (channel occupancy time); and (3) sharing COT among SL users.

In one embodiment, a SL user performs sensing and resource exclusion on the SL interface (PC5 interface).

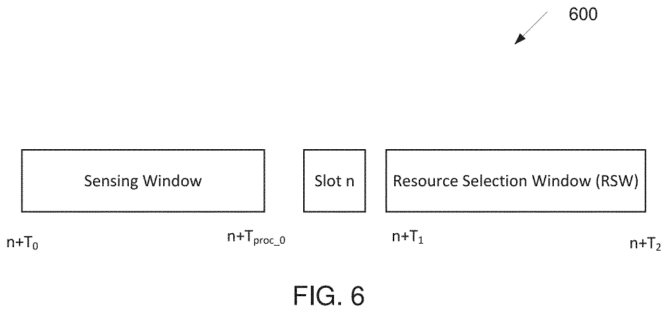

FIG. 6 illustrates an example of timing of the sensing window, resource selection window and a slot 600 according to various embodiments of the present disclosure. An embodiment of the timing of the sensing window, resource selection window and a slot 600 shown in FIG. 6 is for illustration only.

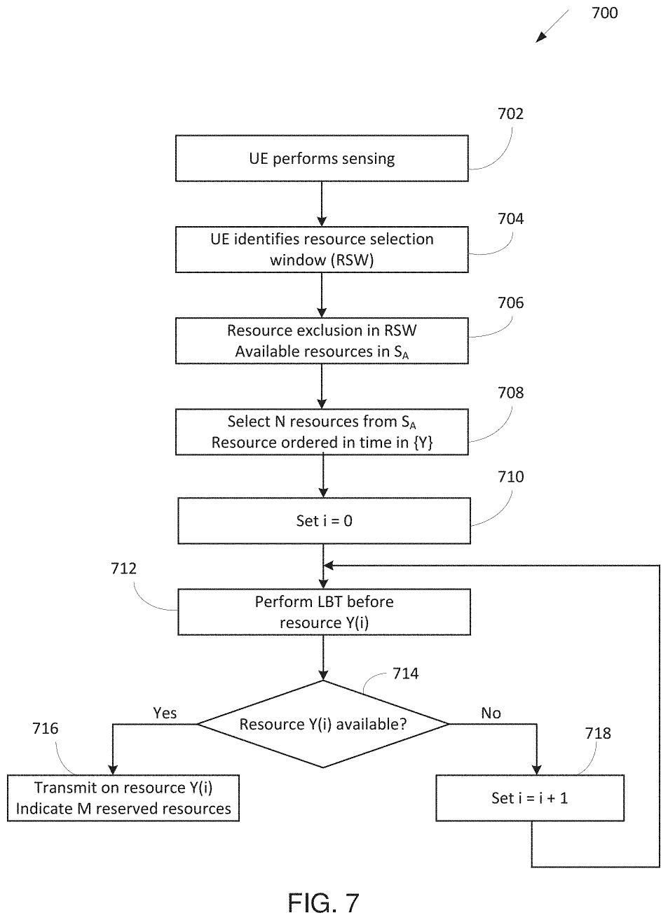

FIG. 7 illustrates a flowchart of UE method 700 for combined SL sensing and LBT channel access operation according to various embodiments of the present disclosure. The UE method 700 as may be performed by a UE (e.g., 111-116 as illustrated in FIG. 1). An embodiment of the UE method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, in 702, a UE performs sensing. Wherein, during a sensing window, sensing involves: (1) decoding PSCCH; (2) measuring the SL RSRP, wherein the SL RSRP can be one of: (i) PSCCH DMRS RSRP of the decoded PSCCH, (ii) PSSCH DMRS RSRP of the PSSCH associated with the decoded PSCCH.

In 704, the UE identifies a resource selection window.

In 706, the UE performs resource exclusion within a resource selection window. The resource exclusion within a resource selection window is based on: (1) reserved resources indicated by the decoded SCI, and further based on: SL RSRP associated with decoded SCI, priority associated with decoded SCI and priority associated with SL transmission; (2) reserved resources indicated by hypothetical SCI assumed in slots not monitored during the sensing window with periodicity configured by higher layer parameter ResourceReservePeriodList-r16.

The remaining single-slot resources within the resource selection window after resource exclusion are available resources for SL transmission. Let S_{A be the set of available resource within the resource selection window.}

In 708, the UE selects N single-slot resources for SL transmission from the available single-slot resources in S_{A. The single-slot resources selected are ordered in time with index i ranging from} 0 to N−1. Wherein, index i=0 corresponds to the first-in-time selected single-slot resource and index i=N−1 corresponds to the last-in-time selected single-slot resource. Let Y be the ordered set of selected single-slot resources, and i is the index of the single-slot resource within Y. In one example, the UE may perform re-evaluation check or pre-emption check, as aforementioned, before transmission in a selected resource.

FIG. 6 shows an example of the timing of the sensing window, resource selection window and a slot n, where the N single-slot resources for SL transmission are selected. Wherein, the sensing window is in the range of slots [n−T₀, n−T_{proc,0}^{SL}), and the resource selection window is in the range of slots [n−T₁, n−T₂].

As illustrated in FIG. 7, in 710, the UE sets i=0. In 712, the UE performs LBT channel access procedure before transmission on the selected resource i. In 714, the UE checks the result of LBT channel access procedure.

In 714, if resource i is available after LBT channel access procedure (i.e., LBT succeeds), the UE transmits on the single-slot resource i, and indicates up to M reserved single-slot resource(s) for future transmissions.

In one example, a UE is (pre-)configured or updated a maximum value of Mₘₐₓ by RRC signaling and/or MAC CE signaling and/or L1 control signaling. The UE selects M such that M≤Mₘₐₓ. In one example, Mₘₐₓ=2.

In one example, a UE is (pre-)configured or updated a value M by RRC signaling and/or MAC CE signaling and/or L1 control signaling.

In one example, the M reserved resources are the M next in time resources after resource i, i.e., i+1,. . . , i+M.

In one example, it is up to the UE to select the M resources. In one example, M=2.

In one example, the M reserved resources satisfy a timing requirement such that the time duration between two consecutive reserved resources is greater than or greater than or equal to Tₘᵢₙ, and the time duration between the resource i and the last indicated reserved single-slot resource is less than or less than or equal Tₘₐₓ. Wherein, Tₘᵢₙ and Tₘₐₓ can be specified in the system specifications and/or (pre-)configured or updated by RRC signaling/MAC CE signaling/L1 control signaling. Tₘᵢₙ and Tₘₐₓ can be in logical slots within the resource pool and/or in physical slots. Tₘᵢₙ or Tₘₐₓ can depend on a UE capability. Tₘᵢₙ or Tₘₐₓ can depend on the sub-carrier spacing of the SL carrier or SL bandwidth part (BWP). Time can be in logical slots or in physical slots.

In 714, if resource i is not available due to LBT channel access procedure (i.e., LBT fails), transmission on resource i is not performed. Set i=i+1 in 718 and go to 712.

In another embodiment, a SL user performs sensing and resource exclusion on the SL interface (PC5 interface).

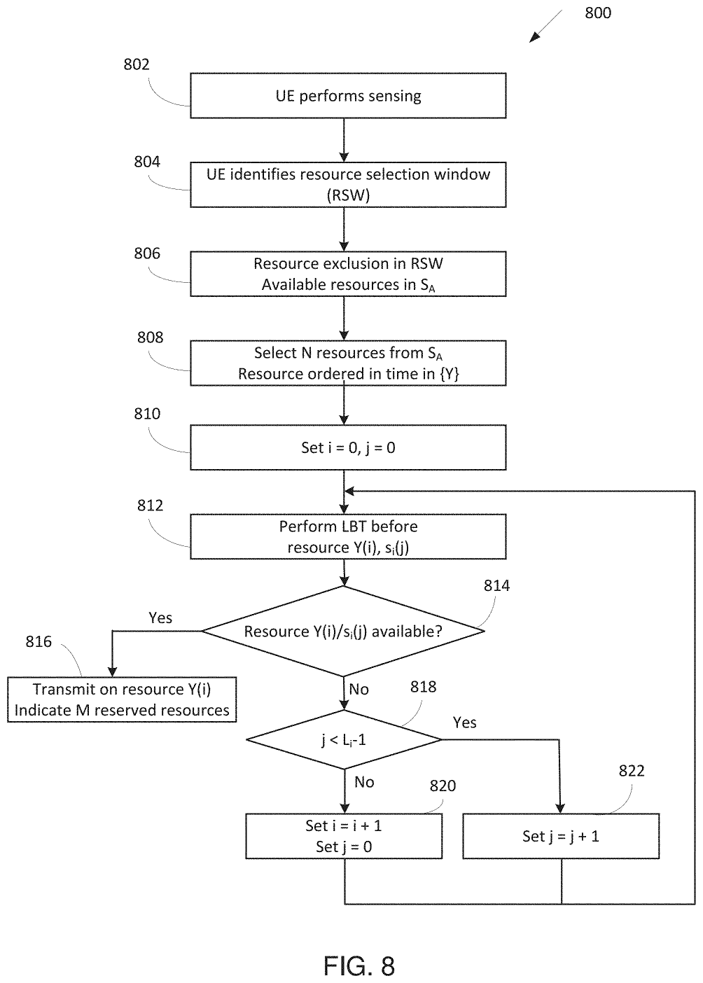

FIG. 8 illustrates another flowchart of UE method 800 for combined SL sensing and LBT channel access operation according to various embodiments of the present disclosure. The UE method 800 as may be performed by a UE (e.g., 111-116 as illustrated in FIG. 1). An embodiment of the UE method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, in step 802, a UE performs sensing. Wherein, during a sensing window, sensing involves: (1) decoding PSCCH; and (2) measuring the SL RSRP, wherein the SL RSRP can be one of; PSCCH DMRS RSRP of the decoded PSCCH, or PSSCH DMRS RSRP of the PSSCH associated with the decoded PSCCH.

In step 804, the UE identifies a resource selection window.

In step 806, the UE performs resource exclusion within a resource selection window. The resource exclusion within a resource selection window is based on: (1) reserved resources indicated by the decoded SCI, and further based on: SL RSRP associated with decoded SCI, priority associated with decoded SCI and priority associated with SL transmission; and (2) reserved resources indicated by hypothetical SCI assumed in slots not monitored during the sensing window with periodicity configured by higher layer parameter ResourceReservePeriodList-r16.

The remaining single-slot resources within the resource selection window after resource exclusion are available resources for SL transmission. Let S_{A} be the set of available resource within the resource selection window.

In step 808, the UE selects N single-slot resources for SL transmission from the available single-slot resources in S_{A}. The single-slot resources selected are ordered in time with index i ranging from 0 to N−1. Wherein, index i=0 corresponds to the first-in-time selected single-slot resource and index i=N−1 corresponds to the last-in-time selected single-slot resource. Let Y be the ordered set of selected single-slot resources, and i is the index of the single-slot resource within Y. In one example, the UE may perform re-evaluation check or pre-emption check, as aforementioned, before transmission in a selected resource.

FIG. 6 shows an example of the timing of the sensing window, resource selection window and a slot n, where the N single-slot resources for SL transmission are selected. Wherein, the sensing window is in the range of slots [n−T₀, n−T_{proc,0}^{SL}) and the resource selection window is in the range of slots [n−T₁, n−T₂].

In single-slot resource i, a UE can start transmission at symbol sᵢ(j), wherein j=0, 1, . . . Lᵢ−1. i.e., there are multiple transmission opportunities within each single-slot resource i. If the first transmission opportunity, corresponding to j=0 in resource i fails due to LBT channel access procedure, the next transmission opportunity in resource i is LBT-checked if that succeeds the SL transmission can proceed, else the next transmission opportunity in resource i is LBT-checked, . . . and so on until the SL transmission is transmitted or there are no more available transmission opportunities in resource i, in which case the UE advances to the next resource i+1.

In one example, Lᵢ can be configured or determined separately for each single-slot resource.

In one, if resource i includes PSFCH, Lᵢ=L_{PSFCH}. If resource i does not include PSFCH, Lᵢ=L_{NONPSFCH}. Wherein, L_{PSFCH} and L_{NONPSFCH} are (pre-)configured and/or updated by RRC signaling/MAC CE signaling/L1 control signaling.

In another example, Lᵢ depends on a number of symbols in resource i available for PSSCH/PSCCH, wherein Lᵢ, as a function of the number of symbols, is (pre-)configured and/or updated by RRC signaling/MAC CE signaling/L1 control signaling.

In another example, Lᵢ depends on a number of symbols in resource i available for SL, wherein Lᵢ, as a function of the number of symbols, is (pre-)configured and/or updated by RRC signaling/MAC CE signaling/L1 control signaling.

In another example, Lᵢ depends on a number of symbols in resource i available for SL as well as the presence or absence of PSFCH, wherein Lᵢ, as a function of the number of symbols and presence/absence of PSFCH, is (pre-)configured and/or updated by RRC signaling/MAC CE signaling/L1 control signaling.

In one example, Lᵢ can be the same for all single-slot resources, i.e., Lᵢ=L for i=0, . . . , N−1. Wherein, L is (pre-)configured and/or updated by RRC signaling/MAC CE signaling/L1 control signaling.

In one example, sᵢ can be configured or determined separately for each SL resource. sᵢ(j) can be relative to the first symbol of resource i.

In one example, if resource i includes PSFCH, sᵢ=s_{PSFCH}. If resource i does not include PSFCH, sᵢ=s_{NONPSFCH}. Wherein, s_{PSFCH} is a set of starting symbols for a slot containing PSFCH, and s_{NONPSFCH} is a set of starting symbols for a slot not containing PSFCH. Wherein, s_{PSFCH} and s_{NONPSFCH} is (pre-)configured and/or updated by RRC signaling/MAC CE signaling/L1 control signaling.

In another example, sᵢ can depend on a number of symbols in resource i available for PSSCH/PSCCH. Wherein the set of starting symbols, sᵢ, as a function of the number of symbols, is (pre-)configured and/or updated by RRC signaling/MAC CE signaling/L1 control signaling.

In another example, sᵢ can depend on a number of symbols in resource i available for SL. Wherein the set of starting symbols, sᵢ as a function of the number of symbols, is (pre-) configured and/or updated by RRC signaling/MAC CE signaling/L1 control signaling.

In another example, sᵢ can depend on a number of symbols in resource i available for SL as well as the presence or absence of PSFCH. Wherein the set of starting symbols, sᵢ as a function of the number of symbols and presence/absence of PSFCH, is (pre-)configured and/or updated by RRC signaling/MAC CE signaling/L1 control signaling.

In one example, sᵢ can be configured or determined based on a rule.

In one example, sᵢ can be the same for all single-slot resources, i.e., sᵢ=s for i=0, . . . , N−1. Wherein, s is (pre-)configured and/or updated by RRC signaling/MAC CE signaling/L1 control signaling.

In one example, sᵢ includes the first symbol of single-slot resource i and all consecutive symbols, and such that the length of the SL transmission is at least K symbols. Wherein, K is specified in the system specifications and/or (pre-)configured and/or updated by RRC signaling/MAC CE signaling/L1 control signaling. K can be counted with or without the first duplicate symbol.

In one example, sᵢ includes the first symbol (svmₛₜₐᵣₜ) and symₛₜₐᵣₜ+D, Symₛₜₐᵣₜ+2D, . . . and such that the length of the SL transmission is at least K symbols. Wherein, K and D are specified in the system specifications and/or (pre-)configured and/or updated by RRC signaling/MAC CE signaling/L1 control signaling. K can be counted with or without the first duplicate symbol.

As illustrated in FIG. 8, in step 810, the UE sets i=0 and j=0.

In step 812, the UE performs LBT channel access procedure before transmission on the selected resource i, starting at symbol sᵢ(j).

In step 814, the UE checks the result of LBT channel access procedure.

In step 814, if resource i starting at symbol sᵢ(j) is available after LBT channel access procedure (i.e., LBT succeeds), UE transmits on the single-slot resource i starting at sᵢ(j) and indicates up to M reserved single-slot resource(s) for future transmissions.

In one example, a UE is (pre-)configured or updated a maximum value of Mₘₐₓ by RRC signaling and/or MAC CE signaling and/or L1 control signaling. The UE selects M such that M≤Mₘₐₓ. In one example, Mₘₐₓ=2.

In one example, a UE is configured or updated a value M by RRC signaling and/or MAC CE signaling and/or L1 control signaling.

In one example, the M reserved resources are the M next in time resources after resource i, i.e., i+1,. . . i+M.

In one example, it is up to the UE to select the M resources. In one example M=2.

In one example, the M reserved resources satisfy a timing requirement such that the time duration between two consecutive reserved resources is greater than or greater than or equal to Tₘᵢₙ, and the time duration between the resource i and the last indicated reserved single-slot resource is less than or less than or equal Tₘₐₓ. Wherein, Tₘᵢₙ and Tₘₐₓ can be specified in the system specifications and/or (pre-)configured or updated by RRC signaling/MAC CE signaling/L1 control signaling. Tₘᵢₙ and Tₘₐₓ can be in logical slots within the resource pool and/or in physical slots. Tₘᵢₙ or Tₘₐₓ can depend on a UE capability. Tₘᵢₙ or Tₘₐₓ can depend on the sub-carrier spacing of the SL carrier or SL BWP. Time can be in logical slots or in physical slots.

If single-slot resource i starting at sᵢ(j) is not available due to LBT channel access procedure (i.e., LBT fails), transmission on resource i starting at sᵢ(j) is not performed. In Step 818 the UE checks the value of j. In step 818, if j<Lᵢ−1, wherein Lᵢ are the number of starting symbols in single-slot resource i, set j=j+1 and go to step 822. Else, set i=i+1 in step 820, set j=0 and go to Step 822.

In another embodiment, a SL user performs sensing.

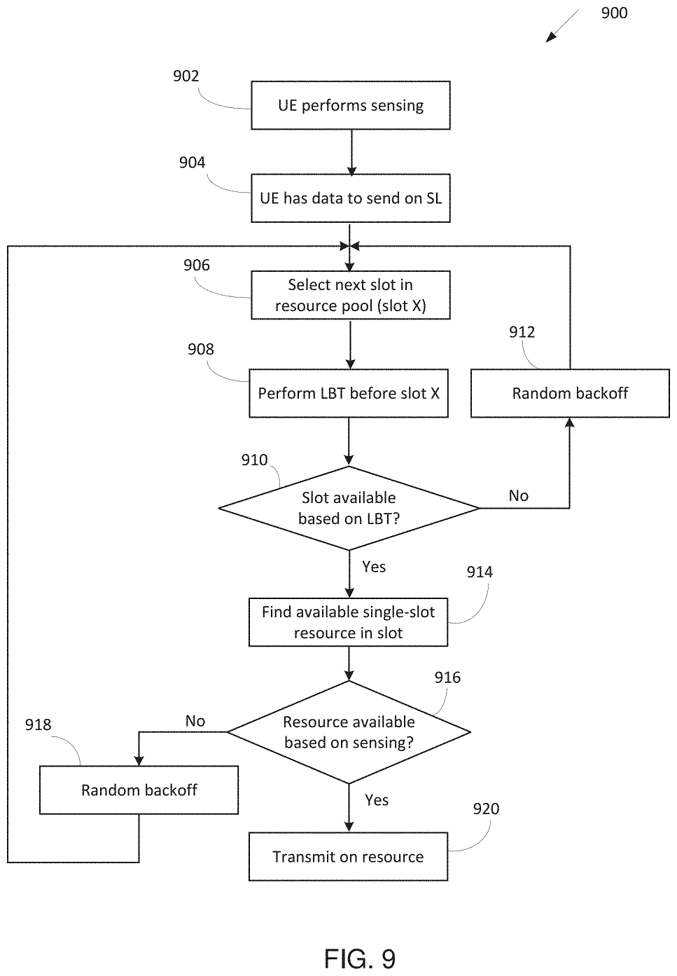

FIG. 9 illustrates yet another flowchart of UE method 900 for combined SL sensing and LBT channel access operation according to various embodiments of the present disclosure. The UE method 900 as may be performed by a UE (e.g., 111-116 as illustrated in FIG. 1). An embodiment of the UE method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, in Step 902, the UE is regularly performing sensing. Wherein, during a sensing window, sensing involves: (1) decoding PSCCH; and (2) measuring the SL RSRP, wherein the SL RSRP can be one of; PSCCH DMRS RSRP of the decoded PSCCH, or PSSCH DMRS RSRP of the PSSCH associated with the decoded PSCCH.

Based on sensing, a UE can identify if a future single-slot resource within the SL resource pool is available for SL transmission or not. A single-slot resource is not available for SL transmission if: (1) the single-slot resource overlaps with a resource reserved by a pervious SL transmission based on sensing; (2) a future period of the single-slot resource overlaps with a resource reserved by a pervious SL transmission based on sensing; and (3) a hypothetical SCI in a slot that has not been sensed due to the UE' s own transmission based on any periodicity that has been configured by higher layers for the resource pool indicates a possible SL reservation in the slot of the single-slot resource or in any slot of a future period of the single-slot resource.

In Step 904, the UE has data to send on the SL interface.

In Step 906, the UE selects a slot in the resource pool. In one example, the slot selected is the next slot in the resource pool, in another example the slot selection is up to UE implementation. In another example, the UE may have performed re-evaluation check or pre-emption check, as aforementioned, before the selected slot. Denote this as slot X.

In Step 908, the UE performs LBT channel access procedure before slot X to determine the availability of slot X for transmission by the UE.

In Step 910, the UE checks the result of LBT channel access procedure.

In Step 910, if slot X is not available due to LBT channel access procedure (i.e., LBT fails), the UE can perform a random backoff in number of logical slots or physical slots in Step 912, and then go to step 906. In a variant example, there is no random backoff, e.g., the next slot in the resource pool can be selected.

Else, in Step 914, slot X is available after LBT channel access procedure (LBT succeeds) the UE selects a single-slot resource (if available) in slot X that is available for SL transmission based on prior sensing.

In Step 916, the UE checks if a single-slot resource is available in slot X based on step 914. In one example, this can be also based on re-evaluation check and/or pre-emption check.

In step 920, if a single-slot resource is selected for SL transmission, the SL data is transmitted on the selected resource. The UE selects M future single-slot resources within the resource pool. The UE indicates M reserved SL resource(s) for future transmissions.

In one example, a UE is configured or updated a maximum value of Mₘₐₓ by RRC signaling and/or MAC CE signaling and/or L1 control signaling. The UE selects M such that M≤Mₘₐₓ. In one example, Mₘₐₓ=2.

In one example, a UE is configured or updated a value M by RRC signaling and/or MAC CE signaling and/or L1 control signaling.

In one example, the M reserved resources are the M next in time resources after resource i, i.e., i+1,. . . i+M.

In one example, it is up to the UE to select the M resources. In one example, M=2.

In one example, the M reserved resources satisfy a timing requirement such that the time duration between two consecutive reserved resources is greater than or greater than or equal to Tₘᵢₙ, and the time duration between the resource i and the last indicated reserved single-slot resource is less than or less than or equal Tₘₐₓ. Wherein, Tₘᵢₙ and Tₘₐₓ can be specified in the system specifications and/or (pre-)configured or updated by RRC signaling/MAC CE signaling/L1 control signaling. Tₘᵢₙ and Tₘₐₓ can be in logical slots within the resource pool and/or in physical slots. Tₘᵢₙ or Tₘₐₓ can depend on a UE capability. Tₘᵢₙ or Tₘₐₓ can depend on the sub-carrier spacing of the SL carrier or SL BWP. Time can be in logical slots or in physical slots.

In Step 916, if no single-slot resource is available in slot X, there is a random backoff in number of logical slots or physical in Step 918 and then go to Step 906. In a variant example, there is no random backoff, e.g., the next slot in the resource pool can be selected.

In another embodiment, a SL user performs sensing.

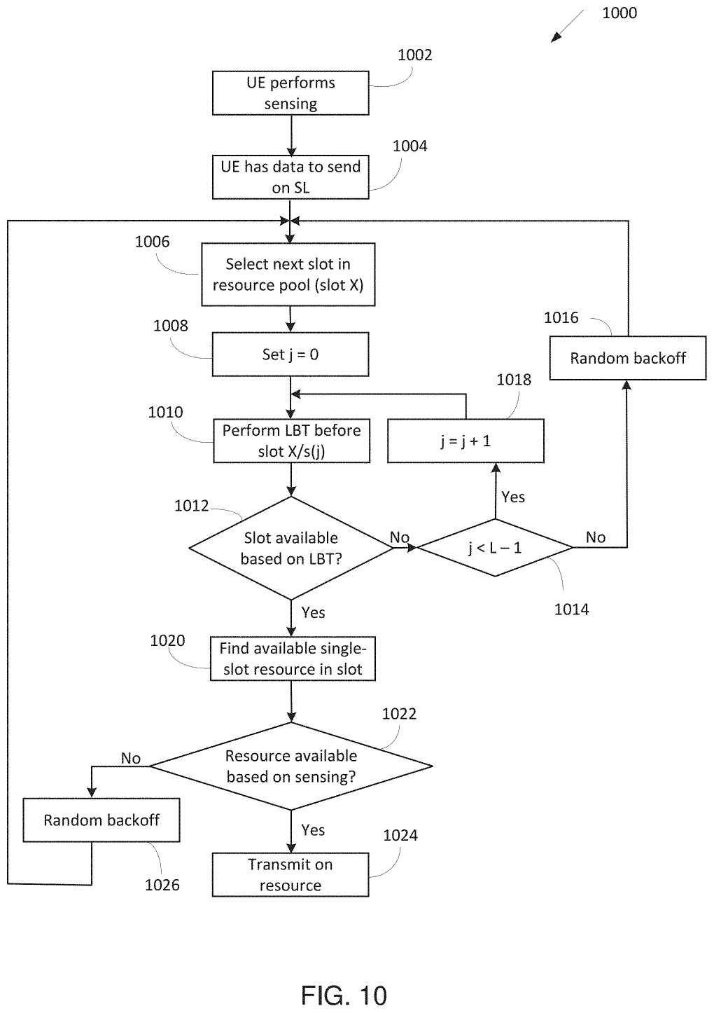

FIG. 10 illustrates yet another flowchart of UE method 1000 for combined SL sensing and LBT channel access operation according to various embodiments of the present disclosure. The UE method 1000 as may be performed by a UE (e.g., 111-116 as illustrated in FIG. 1). An embodiment of the UE method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, in Step 1002, the UE is regularly performing sensing. Wherein, during a sensing window, sensing involves: (1) decoding PSCCH; and (2) measuring the SL RSRP, wherein the SL RSRP can be one of; PSCCH DMRS RSRP of the decoded PSCCH, or PSSCH DMRS RSRP of the PSSCH associated with the decoded PSCCH.

Based on sensing, a UE can identify if a future single-slot resource within the SL resource pool is available for SL transmission or not. A single-slot resource is not available for SL transmission if: (1) the single-slot resource overlaps with a resource reserved by a pervious SL transmission based on sensing; (2) a future period of the single-slot resource overlaps with a resource reserved by a pervious SL transmission based on sensing; and (3) a hypothetical SCI in a slot that has not been sensed due to the UE's own transmission based on any periodicity that has been configured by higher layers for the resource pool indicates a possible SL reservation in the slot of the single-slot resource or in any slot of a future period of the single-slot resource.

In a resource within a slot, a UE can start transmission at symbol s(j), wherein j=0, 1, . . . L−1. i.e., there are multiple transmission opportunities within the slot. If the first transmission opportunity, corresponding to j=0 fails due to LBT channel access procedure, the next transmission opportunity in the slot is LBT-checked if that succeeds the SL transmission can proceed, else the next transmission opportunity in the slot is LBT-checked, . . . and so on until the SL transmission is transmitted or there are no more available transmission opportunities in the slot, in which case the UE evaluates another slot.

In one example, L can be configured or determined separately for each slot.

In one example, if a slot includes PSFCH, L=L_{PSFCH}. If a slot does not include PSFCH, L=L_{NONPSFCH}. Wherein, L_{PSFCH} and L_{NONPSFCH} are (pre-)configured and/or updated by RRC signaling/MAC CE signaling/L1 control signaling.

In another example, L depends on a number of symbols in a slot available for PSSCH/PSCCH, wherein L, as a function of the number of symbols, is (pre-)configured and/or updated by RRC signaling/MAC CE signaling/L1 control signaling.

In another example, L depends on a number of symbols in a slot available for SL, wherein L, as a function of the number of symbols, is (pre-)configured and/or updated by RRC signaling/MAC CE signaling/L1 control signaling.

In another example, L depends on a number of symbols in a slot available for SL as well as the presence or absence of PSFCH, wherein L, as a function of the number of symbols and presence/absence of PSFCH, is (pre-)configured and/or updated by RRC signaling/MAC CE signaling/L1 control signaling.

In one example, L can be the same for all single-slot resources in all slots. Wherein, L is (pre-)configured and/or updated by RRC signaling/MAC CE signaling/L1 control signaling.

In one example, s can be configured or determined separately for each slot. s(j) can be relative to the first SL symbol of a slot.

In one example, if a slot includes PSFCH, s=s_{PSFCH}. If a slot does not include PSFCH, s=s_{NONPSFCH}. Wherein, s_{PSFCH} is a set of starting symbols for a slot containing PSFCH, and s_{NONPSFCH} is a set of starting symbols for a slot not containing PSFCH. Wherein, s_{PSFCH} and s_{NONPSFCH} is (pre-)configured and/or updated by RRC signaling/MAC CE signaling/L1 control signaling.

In another example, s can depend on a number of symbols in a slot available for PSSCH/PSCCH. Wherein the set of starting symbols, s, as a function of the number of symbols, is (pre-)configured and/or updated by RRC signaling/MAC CE signaling/L1 control signaling.

In another example, s can depend on a number of symbols in a slot available for SL. Wherein the set of starting symbols, s as a function of the number of symbols, is (pre-)configured and/or updated by RRC signaling/MAC CE signaling/L1 control signaling.

In another example, s can depend on a number of symbols in a slot available for SL as well as the presence or absence of PSFCH. Wherein the set of starting symbols, s as a function of the number of symbols and presence/absence of PSFCH, is (pre-)configured and/or updated by RRC signaling/MAC CE signaling/L1 control signaling.

In one example, s can be configured or determined based on a rule.

In one example, s can be the same for all single-slot resources in all slots. Wherein, s is (pre-)configured and/or updated by RRC signaling/MAC CE signaling/L1 control signaling.

In one example, s includes the first SL symbol of a slot and all consecutive SL symbols, and such that the length of the SL transmission is at least K symbols. Wherein, K is specified in the system specifications and/or (pre-)configured and/or updated by RRC signaling/MAC CE signaling/L1 control signaling. K can be counted with or without the first duplicate symbol.

In one example, s includes the first SL symbol (symₛₜₐᵣₜ) and symₛₜₐᵣₜ+D. symₛₜₐᵣₜ+2D, . . . and such that the length of the SL transmission is at least K symbols. Wherein, K and D are specified in the system specifications and/or (pre-)configured and/or updated by RRC signaling/MAC CE signaling/L1 control signaling. K can be counted with or without the first duplicate symbol.

AS illustrated in FIG. 10, in Step 1004, the UE has data to send on the SL interface.

In Step 1006, the UE selects a slot in the resource pool. In one example, the slot selected is the next slot in the resource pool, in another example the slot selection is up to UE implementation. In another example, the UE may have performed re-evaluation check or pre-emption check, as aforementioned, before the selected slot. Denote this as slot X.

In Step 1008, the UE sets j=0.

In Step 1010, the UE performs LBT channel access procedure before symbol s(j) of slot X to determine the availability of slot X starting at symbol s(j) for transmission by the UE.

In Step 1012, the UE checks the result of LBT channel access procedure.

In Step 1012, if slot X starting at symbol s(j) is not available due to LBT channel access procedure (i.e., LBT fails), the UE checks the value of j.

In Step 1014, if j<L−1, where L is the number of starting symbols available in slot X for SL transmission. Set j=j+1 in Step 1018 and go to step 1010.

In Step 1014, else (j≤L−1), the UE can perform a random backoff in number of logical slots or physical slots in Step 1016, and then go to step 1006. In a variant example, there is no random backoff, e.g., the next slot in the resource pool can be selected.

In Step 1020, else slot X starting at symbol s(j) is available after LBT channel access procedure (LBT succeeds) the UE selects a single-slot resource (if available) in slot X starting at symbol s(j) that is available for SL transmission based on prior sensing.

In Step 1022, the UE checks if a single-slot resource is available in slot X starting at symbol s(j) based on step 1020. In one example, this can be also based on re-evaluation check and/or pre-emption check.

In Step 1024, if a single-slot resource is selected for SL transmission, the SL data is transmitted on the selected resource. The UE selects M future single-slot resources within the resource pool. The UE indicates M reserved SL resource(s) for future transmissions.

In one example, a UE is configured or updated a maximum value of Mₘₐₓ by RRC signaling and/or MAC CE signaling and/or L1 control signaling. The UE selects M such that M≤Mₘₐₓ. In one example, Mₘₐₓ=2.

In one example, a UE is configured or updated a value M by RRC signaling and/or MAC CE signaling and/or L1 control signaling.

In one example, the M reserved resources are the M next in time resources after resource i, i.e., i+1,. . . i+M.

In one example, it is up to the UE to select the M resources. In one example, M=2.

In one example, the M reserved resources satisfy a timing requirement such that the time duration between two consecutive reserved resources is greater than or greater than or equal to Tₘᵢₙ, and the time duration between the resource i and the last indicated reserved single-slot resource is less than or less than or equal Tₘₐₓ. Wherein, Tₘᵢₙ and Tₘₐₓ can be specified in the system specifications and/or (pre-)configured or updated by RRC signaling/MAC CE signaling/L1 control signaling. Tₘᵢₙ and Tₘₐₓ can be in logical slots within the resource pool and/or in physical slots. Tₘᵢₙ or Tₘₐₓ can depend on a UE capability. Tₘᵢₙ or Tₘₐₓ can depend on the sub-carrier spacing of the SL carrier or SL BWP. Time can be in logical slots or in physical slots.

In Step 1026, if no single-slot resource is available in slot X, there is a random backoff in number of logical slots or physical slots and then go to Step 1006. In a variant example, there is no random backoff, e.g., the next slot in the resource pool can be selected.

In another embodiment, a SL user performs sensing.

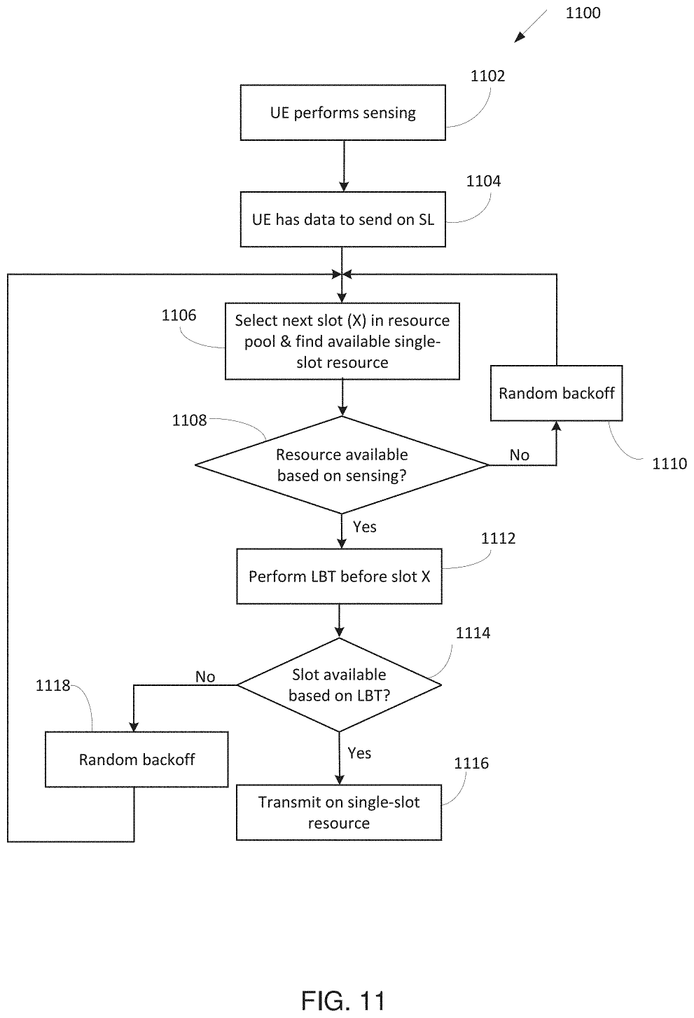

FIG. 11 illustrates yet another flowchart of UE method 1100 for combined SL sensing and LBT channel access operation according to various embodiments of the present disclosure. The UE method 1100 as may be performed by a UE (e.g., 111-116 as illustrated in FIG. 1). An embodiment of the UE method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, in Step 1, the UE is regularly performing sensing. Wherein, during a sensing window, sensing involves: (1) decoding PSCCH; and (2) measuring the SL RSRP, wherein the SL RSRP can be one of; PSCCH DMRS RSRP of the decoded PSCCH, or PSSCH DMRS RSRP of the PSSCH associated with the decoded PSCCH.

Based on sensing, a UE can identify if a future single-slot resource within the SL resource pool is available for SL transmission or not. A single-slot resource is not available for SL transmission if: (1) the single-slot resource overlaps with a resource reserved by a pervious SL transmission based on sensing; (2) a future period of the single-slot resource overlaps with a resource reserved by a pervious SL transmission based on sensing; and (3) a hypothetical SCI in a slot that has not been sensed due to the UE's own transmission based on any periodicity that has been configured by higher layers for the resource pool indicates a possible SL reservation in the slot of the single-slot resource or in any slot of a future period of the single-slot resource.

In Step 1104, the UE has data to send on the SL interface.

In Step 1106, the UE selects a slot in the resource pool. In one example, the slot selected is the next slot in the resource pool, in another example the slot selection is up to UE implementation. In another example, the UE may have performed re-evaluation check or pre-emption check, as aforementioned, before the selected slot. Denote this as slot X.

In Step 1108, the UE checks if a single-slot resource is available in slot X. In one example, this may take into account re-evaluation check or pre-emption check, as aforementioned, before slot X.

In Step 1108, if no single-slot resource is available in slot X, there is a random backoff in number of logical slots or physical slots in Step 1110, and then go to step 1106. In a variant example, there is no random backoff, e.g., the next slot in the resource pool can be selected.

In step 1108, if a single-slot resource is available in slot X, the UE performs LBT channel access procedure in Step 1112 before slot X to determine the availability of slot X for transmission by the UE.

In Step 1114, the UE checks the result of LBT channel access procedure.

In Step 1114, if slot X is not available due to LBT channel access procedure (i.e., LBT fails), the UE can perform a random backoff in number of logical slots or physical slots in Step 1118, and then go to Step 1106. In a variant example, there is no random backoff, e.g., the next slot in the resource pool can be selected.

In Step 1114, Else slot X is available after LBT channel access procedure (LBT succeeds). The SL data is transmitted on the selected resource. The UE selects M future single-slot resources within the resource pool. The UE indicates M reserved SL resource(s) for future transmissions.

In one example, a UE is configured or updated a maximum value of Mₘₐₓ by RRC signaling and/or MAC CE signaling and/or L1 control signaling. The UE selects M such that M≤Mₘₐₓ. In one example, Mₘₐₓ=2.

In one example, a UE is configured or updated a value M by RRC signaling and/or MAC CE signaling and/or L1 control signaling.

In one example, the M reserved resources are the M next in time resources after resource i, i.e., i+1,. . . i+M.

In one example, it is up to the UE to select the M resources. In one example, M=2.

In one example, the M reserved resources satisfy a timing requirement such that the time duration between two consecutive reserved resources is greater than or greater than or equal to Tₘᵢₙ, and the time duration between the resource i and the last indicated reserved single-slot resource is less than or less than or equal Tₘₐₓ. Wherein, Tₘᵢₙ and Tₘₐₓ can be specified in the system specifications and/or (pre-)configured or updated by RRC signaling/MAC CE signaling/L1 control signaling. Tₘᵢₙ and Tₘₐₓ can be in logical slots within the resource pool and/or in physical slots. Tₘᵢₙ or Tₘₐₓ can depend on a UE capability. Tₘᵢₙ or Tₘₐₓ can depend on the sub-carrier spacing of the SL carrier or SL BWP. Time can be in logical slots or in physical slots.

In another embodiment, a SL user performs sensing.

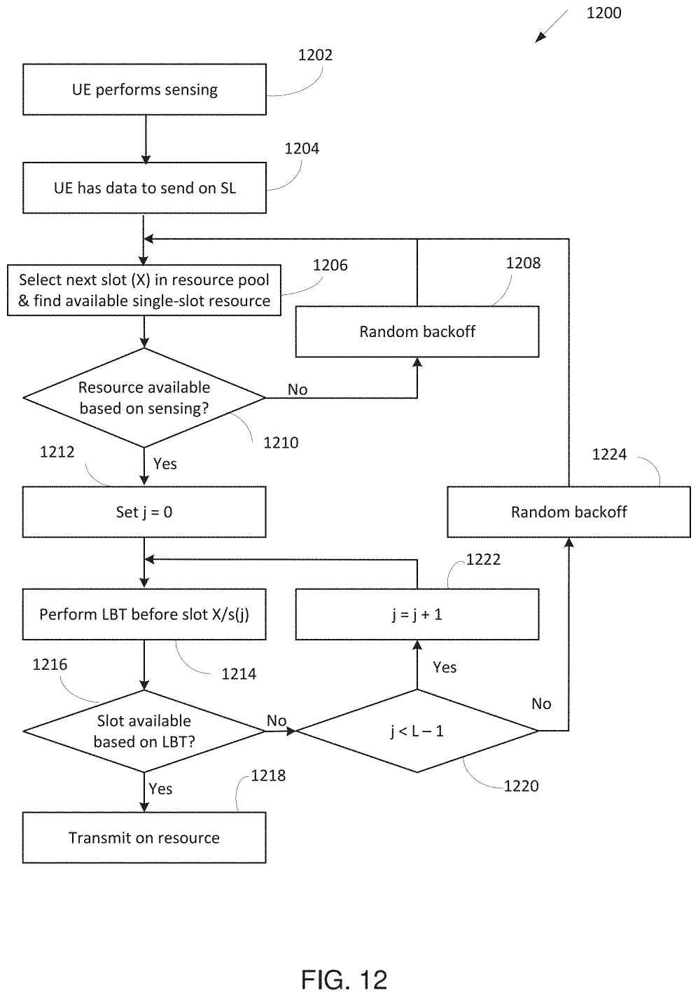

FIG. 12 illustrates yet another flowchart of UE method 1200 for combined SL sensing and LBT channel access operation according to various embodiments of the present disclosure. The UE method 1200 as may be performed by a UE (e.g., 111-116 as illustrated in FIG. 1). An embodiment of the UE method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, in Step 1202, the UE is regularly performing sensing. Wherein, during a sensing window, sensing involves: (1) decoding PSCCH; and (2) measuring the SL RSRP, wherein the SL RSRP can be one of; PSCCH DMRS RSRP of the decoded PSCCH, or PSSCH DMRS RSRP of the PSSCH associated with the decoded PSCCH.

Based on sensing, a UE can identify if a future single-slot resource within the SL resource pool is available for SL transmission or not. A single-slot resource is not available for SL transmission if: (1) the single-slot resource overlaps with a resource reserved by a pervious SL transmission based on sensing; (2) a future period of the single-slot resource overlaps with a resource reserved by a pervious SL transmission based on sensing; (3) a hypothetical SCI in a slot that has not been sensed due to the UE's own transmission based on any periodicity that has been configured by higher layers for the resource pool indicates a possible SL reservation in the slot of the single-slot resource or in any slot of a future period of the single-slot resource.

In a resource within a slot, a UE can start transmission at symbol s(j), wherein j=0,1, . . . L−1. i.e., there are multiple transmission opportunities within the slot. If the first transmission opportunity, corresponding to j=0 in the fails due to LBT channel access procedure, the next transmission opportunity in the slot is LBT-checked if that succeeds the SL transmission can proceed, else the next transmission opportunity in the slot is LBT-checked, . . . and so on until the SL transmission is transmitted or there are no more available transmission opportunities in the slot, in which case the UE evaluates another slot.

In one example, L can be configured or determined separately for each slot.

In one example, if a slot includes PSFCH, L=L_{PSFCH}. If a slot does not include PSFCH, L=L_{NONPSFCH}. Wherein, L_{PSFCH} and L_{NONPSFCH} are (pre-)configured and/or updated by RRC signaling/MAC CE signaling/L1 control signaling.

In another example, L depends on a number of symbols in a slot available for PSSCH/PSCCH, wherein L, as a function of the number of symbols, is (pre-)configured and/or updated by RRC signaling/MAC CE signaling/L1 control signaling.

In yet another example, L depends on a number of symbols in a slot available for SL, wherein L, as a function of the number of symbols, is (pre-)configured and/or updated by RRC signaling/MAC CE signaling/L1 control signaling.

In yet another example, L depends on a number of symbols in a slot available for SL as well as the presence or absence of PSFCH, wherein L, as a function of the number of symbols and presence/absence of PSFCH, is (pre-)configured and/or updated by RRC signaling/MAC CE signaling/L1 control signaling.

In one example, L can be the same for all single-slot resources in all slots. Wherein, L is (pre-)configured and/or updated by RRC signaling/MAC CE signaling/L1 control signaling.

In one example, s can be configured or determined separately for each slot. s(j) can be relative to the first SL symbol of a slot.

In one example, if a slot includes PSFCH, s=s_{PSFCH}. If a slot does not include PSFCH, s=s_{NONPSFCH}. Wherein, s_{PSFCH} is a set of starting symbols for a slot containing PSFCH, and s_{NONPSFCH} is a set of starting symbols for a slot not containing PSFCH. Wherein, s_{PSFCH} and S_{NONPSFCH} is (pre-)configured and/or updated by RRC signaling/MAC CE signaling/L1 control signaling.

In another example, s can depend on a number of symbols in a slot available for PSSCH/PSCCH. Wherein the set of starting symbols, s, as a function of the number of symbols, is (pre-)configured and/or updated by RRC signaling/MAC CE signaling/L1 control signaling.

In yet another example, s can depend on a number of symbols in a slot available for SL. Wherein the set of starting symbols, s as a function of the number of symbols, is (pre-) configured and/or updated by RRC signaling/MAC CE signaling/L1 control signaling.

In yet another example, s can depend on a number of symbols in a slot available for SL as well as the presence or absence of PSFCH. Wherein the set of starting symbols, s as a function of the number of symbols and presence/absence of PSFCH, is (pre-)configured and/or updated by RRC signaling/MAC CE signaling/L1 control signaling.

In one example, s can be configured or determined based on a rule.

In one example, s can be the same for all single-slot resources in all slots. Wherein, s is (pre-)configured and/or updated by RRC signaling/MAC CE signaling/L1 control signaling.

In one example, s includes the first SL symbol of a slot and all consecutive SL symbols, and such that the length of the SL transmission is at least K symbols. Wherein, K is specified in the system specifications and/or (pre-)configured and/or updated by RRC signaling/MAC CE signaling/L1 control signaling. K can be counted with or without the first duplicate symbol.

In one example, s includes the first SL symbol (symₛₜₐᵣₜ) and symₛₜₐᵣₜ+D, symₛₜₐᵣₜ+2D, . . . and such that the length of the SL transmission is at least K symbols. Wherein, K and D are specified in the system specifications and/or (pre-)configured and/or updated by RRC signaling/MAC CE signaling/L1 control signaling. K can be counted with or without the first duplicate symbol.

As illustrated in FIG. 12, in Step 1204, the UE has data to send on the SL interface.

In step 1206, the UE selects a slot in the resource pool. In one example, the slot selected is the next slot in the resource pool, in another example the slot selection is up to UE implementation. In another example, the UE may have performed re-evaluation check or pre-emption check, as aforementioned, before the selected slot. Denote this as slot X.

In Step 1208, the UE checks if a single-slot resource is available in slot X. In one example, this may take into account re-evaluation check or pre-emption check, as aforementioned, before slot X.

In Step 1210, if no single-slot resource is available in slot X, there is a random backoff in number of logical slots or physical slots in Step; 1208, and then go to Step 1206. In a variant example, there is no random backoff, e.g., the next slot in the resource pool can be selected.

In Step 1210, if a single-slot resource is available in slot X, Set j=0 in Step 1212.

In Step 1214, the UE performs LBT channel access procedure before symbol s(j) of slot X to determine the availability of slot X starting at symbol s(j) for transmission by the UE.

In Step 1216, the UE checks the result of LBT channel access procedure.

In Step 1216, if slot X starting at symbol s(j) is not available due to LBT channel access procedure (i.e., LBT fails), the UE checks the value of j in Step 1220.

In Step 1220, if j<L−1, where L is the number of starting symbols available in slot X for SL transmission. In Step 1222, the UE sets j=j+1 and go to Step 1214.

In Step 1220, else (j≥L−1), the UE can perform a random backoff in number of logical slots or physical slots in Step 1224, and then go to Step 1206. In a variant example, there is no random backoff, e.g., the next slot in the resource pool can be selected.

In Step 1216, else slot X starting at symbol s(j) is available after LBT channel access procedure (LBT succeeds). The SL data is transmitted on the selected resource in Step 1218. The UE selects M future single-slot resources within the resource pool. The UE indicates M reserved SL resource(s) for future transmissions.

In one example, a UE is configured or updated a maximum value of Mₘₐₓ by RRC signaling and/or MAC CE signaling and/or L1 control signaling. The UE selects M such that M≤Mₘₐₓ. In one example, Mₘₐₓ₌2.

In one example, a UE is configured or updated a value M by RRC signaling and/or MAC CE signaling and/or L1 control signaling.

In one example, the M reserved resources are the M next in time resources after resource i, i.e., i+1,. . . i+M.

In one example, it is up to the UE to select the M resources. In one example, M=2.

In one example, the M reserved resources satisfy a timing requirement such that the time duration between two consecutive reserved resources is greater than or greater than or equal to Tₘᵢₙ, and the time duration between the resource i and the last indicated reserved single-slot resource is less than or less than or equal Tₘₐₓ. Wherein, Tₘᵢₙ and Tₘₐₓ can be specified in the system specifications and/or (pre-)configured or updated by RRC signaling/MAC CE signaling/L1 control signaling. Tₘᵢₙ and Tₘₐₓ can be in logical slots within the resource pool and/or in physical slots. Tₘᵢₙ or Tₘₐₓ can depend on a UE capability. Tₘᵢₙ or Tₘₐₓ can depend on the sub-carrier spacing of the SL carrier or SL BWP. Time can be in logical slots or in physical slots.

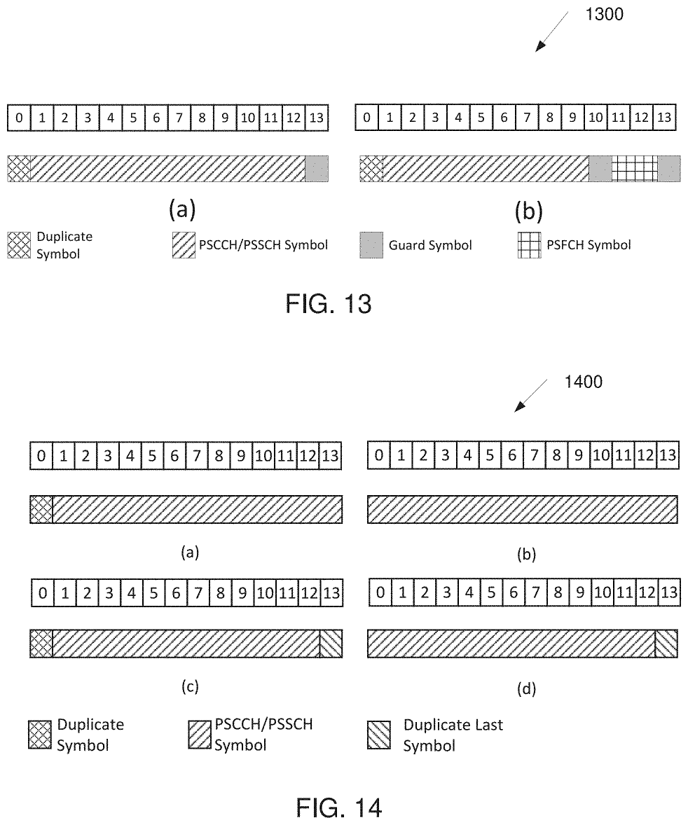

FIG. 13 illustrates an example of slot structure 1300 according to various embodiments of the present disclosure. An embodiment of the slot structure 1300 shown in FIG. 13 is for illustration only.

The slot structure in time domain for the SL interface is illustrated in FIG. 113 (e.g., (a) and (b)). The symbols allocated to SL transmission in a slot are configured by startSLsymbols (first SL symbol of the slot) and lengthSLsymbols (the number of SL symbols in a slot. FIG. 13, illustrates an example when all symbols of a slot are allocated to SL, i.e., startSLsymbols is 0 and lengthSLsymbols is 14. FIG. 13 (e.g., (a)) is the SL slot structure with no PFSCH in the slot.

The first SL symbol is a duplicate of the second SL symbol.

The PSCCH/PSSCH channels are allocated to the remaining but one SL symbols of the slot until the second to last SL symbol of the slot.

The last SL symbol of the slot is a guard symbol with no SL transmission.

FIG. 13 (e.g., (b)) is the SL slot structure with a PSFCH in the slot.

The first SL symbol is a duplicate of the second SL symbol.

Following the duplicate symbol, the PSCCH/PSSCH channels are allocated until the fifth to last SL symbol of the slot.

Following the PSCCH/PSSCH channel is a first guard symbol.

Following the first guard symbol are two symbols for PSFCH. The first symbol is a duplicate of the second symbol.

The last SL symbol of the slot is a second guard symbol.

The presences of guard symbols transmission gaps in a slot leads to a break in transmission and can allow other users sharing the unlicensed spectrum, for example using other radio access technologies to acquire the spectrum, and thus may require another LBT channel access operation by the SL user before accessing the spectrum. In order to avoid excessive LBT channel operations a new slot structure without gaps is considered. In one instance, at least one of the examples in this embodiment is applicable to a SL operating with shared spectrum channel access.

FIG. 14 illustrates another example of slot 1400 structure according to various embodiments of the present disclosure. An embodiment of the slot structure 1400 shown in FIG. 14 is for illustration only.

In one example, a SL slot with no PSFCH can have all SL symbols after the duplicate symbol allocated to PSCCH/PSSCH. This is illustrated in FIG. 14 (e.g., (a)).

In another example, a SL slot with no PSFCH can have no duplicate symbols and all SL symbols allocated to PSCCH/PSSCH. This is illustrated in FIG. 14 (e.g., (b)).

In another example, a SL slot with no PSFCH slot can have all SL symbols after the first duplicate symbol, but the last SL symbol of the slot, allocated to PSCCH/PSSCH, the last SL symbol of the slot is a duplicate of the last PSCCH/PSSCH symbol. This is illustrated in FIG. 14 (e.g., (c)). In a variant example, the last symbol can include a placeholder transmission (e.g., a reference signal).

In another example, a SL slot with no PSFCH slot can have all SL symbols, but the last SL symbol of the slot, allocated to PSCCH/PSSCH, the last SL symbol of the slot is a duplicate of the last PSCCH/PSSCH symbol. There is no duplicate first symbol in this example. This is illustrated in FIG. 14(e.g., (d)). In a variant example, the last symbol can include a placeholder transmission (e.g., a reference signal).

In one example, a SL slot with PSFCH can have no guard symbol between the PSCCH/PSSCH symbols and PSFCH symbols and no guard symbol at the end. There is a duplicate symbol for PSCCH/PSSCH.

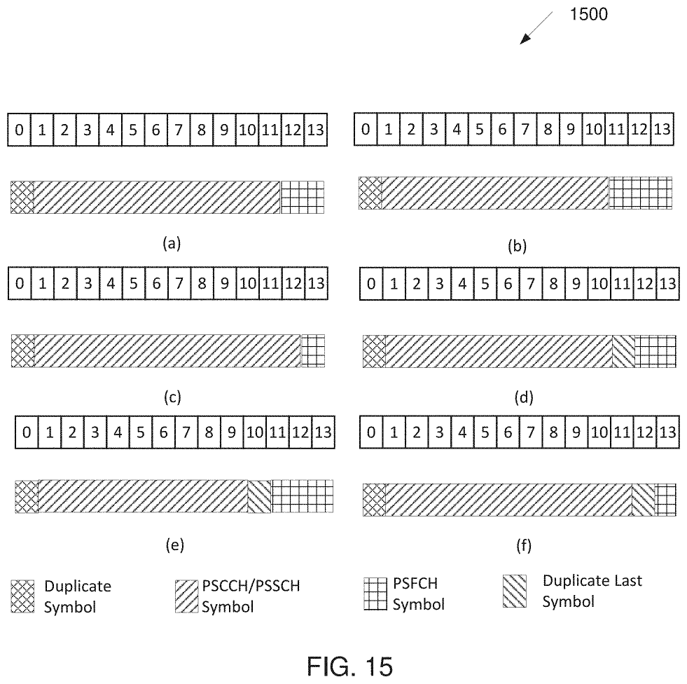

FIG. 15 illustrates yet another example of slot structure 1500 according to various embodiments of the present disclosure. An embodiment of the slot structure 1500 shown in FIG. 15 is for illustration only.

FIG. 15(e.g., (a)) illustrates an example with 2 symbols allocated to PSFCH.

FIG. 15(e.g., (b)) illustrates an example with 3 symbols allocated to PSFCH.

FIG. 15(e.g., (c)) illustrates an example with 1 symbol allocated to PSFCH.

FIG. 15(e.g., (d)) illustrates an example with 2 symbols allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

FIG. 15(e.g., (e)) illustrates an example with 3 symbols allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

FIG. 15(e.g., (f)) illustrates an example with 1 symbol allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

In another variant the last SL symbol of the slot is a placeholder transmission (e.g., a reference signal).

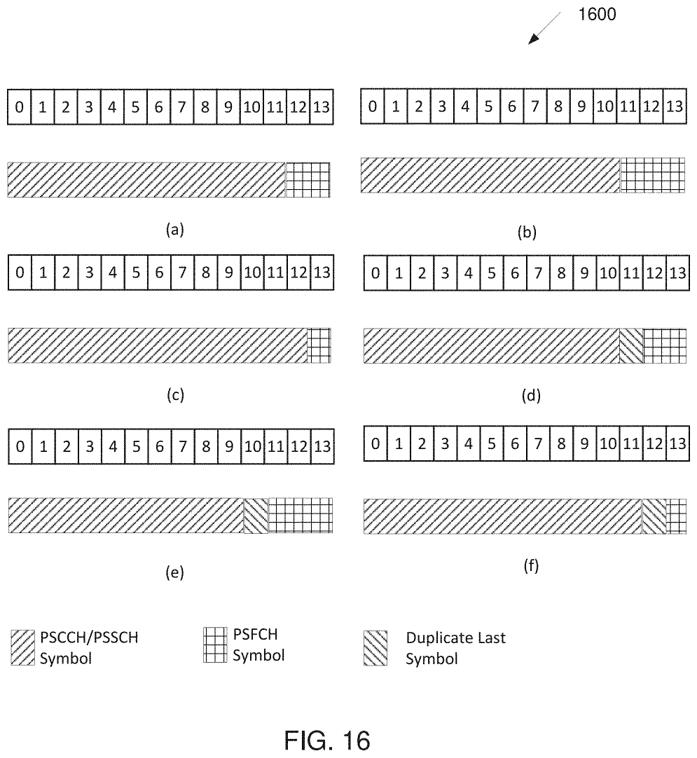

FIG. 16 illustrates yet another example of slot structure 1600 according to various embodiments of the present disclosure. An embodiment of the slot structure 1600 shown in FIG. 16 is for illustration only.

In one example, a SL slot with PSFCH can have no guard symbol between the PSCCH/PSSCH symbols and PSFCH symbols and no guard symbol at the end. There is no duplicate symbol for PSCCH/PSSCH.

FIG. 16 (e.g., (a)) illustrates an example with 2 symbols allocated to PSFCH.

FIG. 16 (e.g., (b)) illustrates an example with 3 symbols allocated to PSFCH.

FIG. 16 (e.g., (c)) illustrates an example with 1 symbol allocated to PSFCH.

FIG. 16 (e.g., (d)) illustrates an example with 2 symbols allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

FIG. 16(e.g., (e)) illustrates an example with 3 symbols allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

FIG. 16(e.g., (f)) illustrates an example with 1 symbol allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

In another variant the last SL symbol of the slot is a placeholder transmission (e.g., a reference signal).

In one example, a SL slot with PSFCH can have no guard symbol between the PSCCH/PSSCH symbols and PSFCH symbols and but with a guard symbol at the end. There is a duplicate symbol for PSCCH/PSSCH.

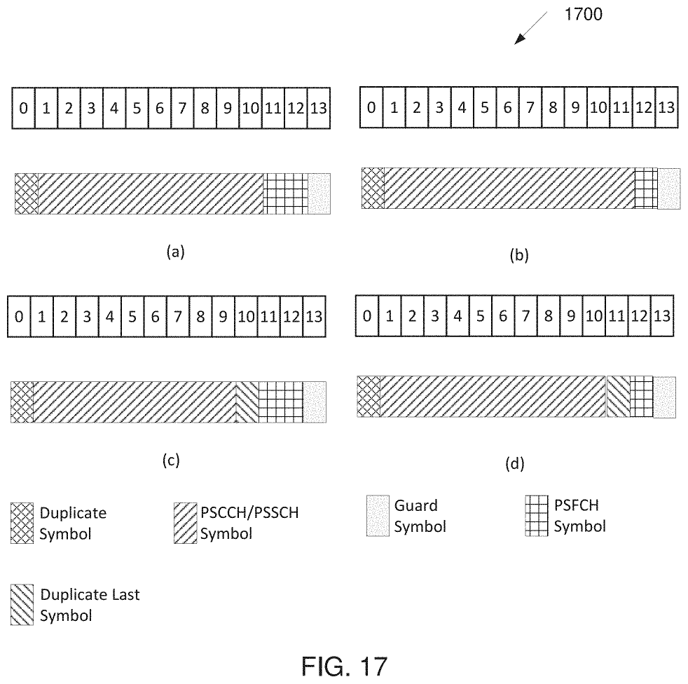

FIG. 17 illustrates yet another example of slot structure 1700 according to various embodiments of the present disclosure. An embodiment of the slot structure 1700 shown in FIG. 17 is for illustration only.

FIG. 17 (e.g., (a)) illustrates an example with 2 symbols allocated to PSFCH.

FIG. 17 (e.g., (b)) illustrates an example with 1 symbol allocated to PSFCH.

FIG. 17 (e.g., (c)) illustrates an example with 2 symbols allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

FIG. 17 (e.g., (d)) illustrates an example with 1 symbol allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

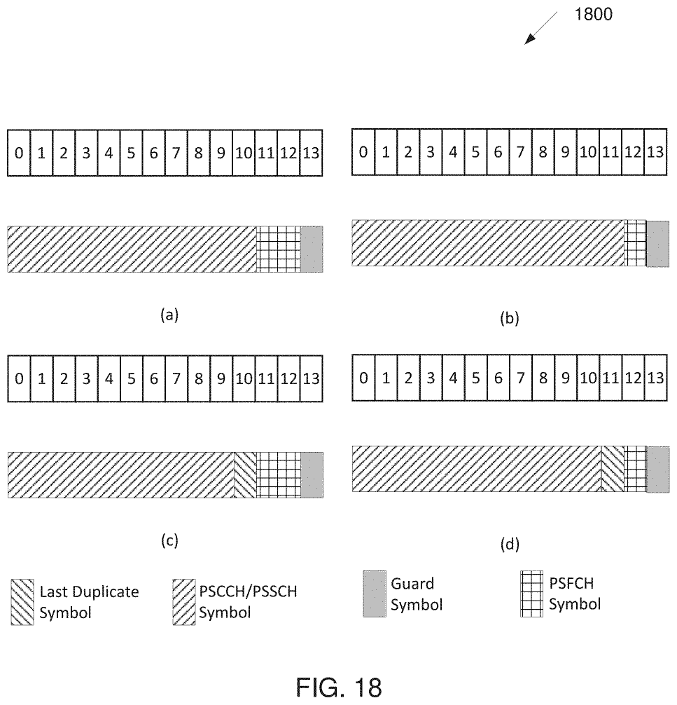

FIG. 18 illustrates yet another example of slot structure 1800 according to various embodiments of the present disclosure. An embodiment of the slot structure 1800 shown in FIG. 18 is for illustration only.

In one example, a SL slot with PSFCH can have no guard symbol between the PSCCH/PSSCH symbols and PSFCH symbols but with a guard symbol at the end. There is no duplicate symbol for PSCCH/PSSCH.

FIG. 18 (e.g., (a)) illustrates an example with 2 symbols allocated to PSFCH.

FIG. 18 (e.g., (b)) illustrates an example with 1 symbol allocated to PSFCH.

FIG. 18 (e.g., (c)) illustrates an example with 2 symbols allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

FIG. 18 (e.g., (d)) illustrates an example with 1 symbol allocated to PSFCH and a duplicate of the last symbol of the PSCCH/PSSCH transmission. In a variant, the symbol between the PSCCH/PSSCH transmission and the PSFCH transmission is a placeholder transmission (e.g., a reference signal).

In one example, a counter is included in the SCI. The counter indicates the number of slots the SL channel has been used without LBT operation channel access, or the number of remaining SL transmissions without LBT channel access procedure.

In one example, in the first SL slot transmission after LBT succeeds, the counter is initialized to zero (or one). Every consecutive SL slot transmitted without LBT channel access procedure; the value of the counter is incremented by 1.

In another example, in the first SL slot transmission after LBT succeeds, the counter is set to an initial value. Every consecutive SL slot transmitted without LBT channel access procedure; the value of the counter is decremented by 1 until the value reaches zero.

In one example, the counter is included in the first stage SCI (e.g., transmitted on PSCCH).

In another example, the counter is included in the second stage SCI (e.g., transmitted on PSSCH).

In a variant example, the counter is associated with sub-slots. The first SL sub-slot transmission after LBT channel access procedure the counter is initialized to zero (or one). Every consecutive SL sub-slot transmitted without LBT channel access procedure; the value of the counter is incremented by 1. A slot can consist of more than one sub-slot, for example if a sub-slot has 7 symbols, a 14-symbol slot includes two 7-symbol sub-slots. In another example, if a sub-slot has 4 symbols, a 14-symbol slot includes three 4-symbol sub-slots. In another example, if a sub-slot has 2 symbols, a 14-symbol slot includes seven 2-symbol sub-slots.

In this disclosure a short LBT channel access procedure can refer to one of the following: (1) LBT associated with a Type 2A channel access procedure, wherein, the UE may transmit the transmission immediately after sensing the channel to be idle for at least a sensing interval T_{short_sl}=25 μs. T_{short_sl} consists of a duration T_{f}=16 μs immediately followed by one slot sensing slot and T_{f} includes a sensing slot at start of T_{f}. The channel is considered to be idle for T_{short_sl} if both sensing slots of T_{short_sl} are sensed to be idle; or (2) LBT associated with a Type 2B channel access procedure, wherein, the UE may transmit the transmission immediately after sensing the channel to be idle within a duration of T_{f}=16 μs . T_{f} includes a sensing slot that occurs within the last 9 μs of T_{f}. The channel is considered to be idle within the duration T_{f} if the channel is sensed to be idle for total of at least 5 μs with at least 4 μs of sensing occurring in the sensing slot.

In one example, a counter is included in the SCI. The counter indicates the number of slots the SL channel has been used with short LBT channel access operation, or the number of remaining SL transmissions that can use short LBT channel access procedure.

In one example, in the first SL slot transmission after LBT succeeds, the counter is initialized to zero (or one). Every consecutive SL slot transmitted with short LBT channel access procedure; the value of the counter is incremented by 1.

In another example, in the first SL slot transmission after LBT succeeds, the counter is set to an initial value. Every consecutive SL slot transmitted with short LBT channel access procedure; the value of the counter is decremented by 1 until the value reaches zero.

In one example, the counter is included in the first stage SCI (e.g., transmitted on PSCCH).

In another example, the counter is included in the second stage SCI (e.g., transmitted on PSSCH).

In a variant example, the counter is associated with sub-slots. The first SL sub-slot transmission after LBT channel access procedure the counter is initialized to zero (or one). Every consecutive SL sub-slot transmitted with short LBT channel access procedure; the value of the counter is incremented by 1.

In one example, a counter threshold is configured (e.g., following other examples discussed herein). For a SL transmission in a SL slot (e.g., slot X) (or a SL sub-slot, e.g., sub-slot X), wherein the previous slot (or sub-slot) before slot X (or sub-slot X) had a SL transmission, and the SL transmission is till the last symbol of the slot (or sub-slot), e.g., following the examples of FIGS. 14, 15, and 16. The SL transmission in slot X (or sub-slot X) can proceed without LBT channel access operation, or short LBT channel access operation if the value of the counter in the previous slot (or sub-slot) before slot X (or sub-slot X) is less than (or less than or equal to) the configured threshold.

In one example, a single threshold is configured for all SL transmission priorities.

In another example, a threshold is configured for each SL transmission priority.

In another example, a threshold is configured for a range of transmission priories. For example, transmission priorities in a first range, have a first threshold value, transmission priorities in a second range, have a second threshold value and so on.

In one example, an initial value is configured (e.g., following other examples described herein). For a SL transmission in a SL slot (e.g., slot X) (or a SL sub-slot, e.g., sub-slot X), wherein the previous slot (or sub-slot) before slot X (or sub-slot X) had a SL transmission, and the SL transmission is till the last symbol of the slot (or sub-slot), e.g., following the examples of FIGS. 14, 15, and 16. The SL transmission in slot X (or sub-slot X) can proceed without LBT channel access operation, or short LBT channel access operation if the value of the counter in the previous slot (or sub-slot) before slot X (or sub-slot X) has not reached zero.

In one example, a single initial value is configured for all SL transmission priorities.

In another example, an initial value is configured for each SL transmission priority.

In another example, an initial value is configured for a range of transmission priories. For example, transmission priorities in a first range, have a first initial value, transmission priorities in a second range, have a second initial value and so on.

In one embodiment a SL user performs sensing and resource exclusion on the SL interface (PC5 interface).

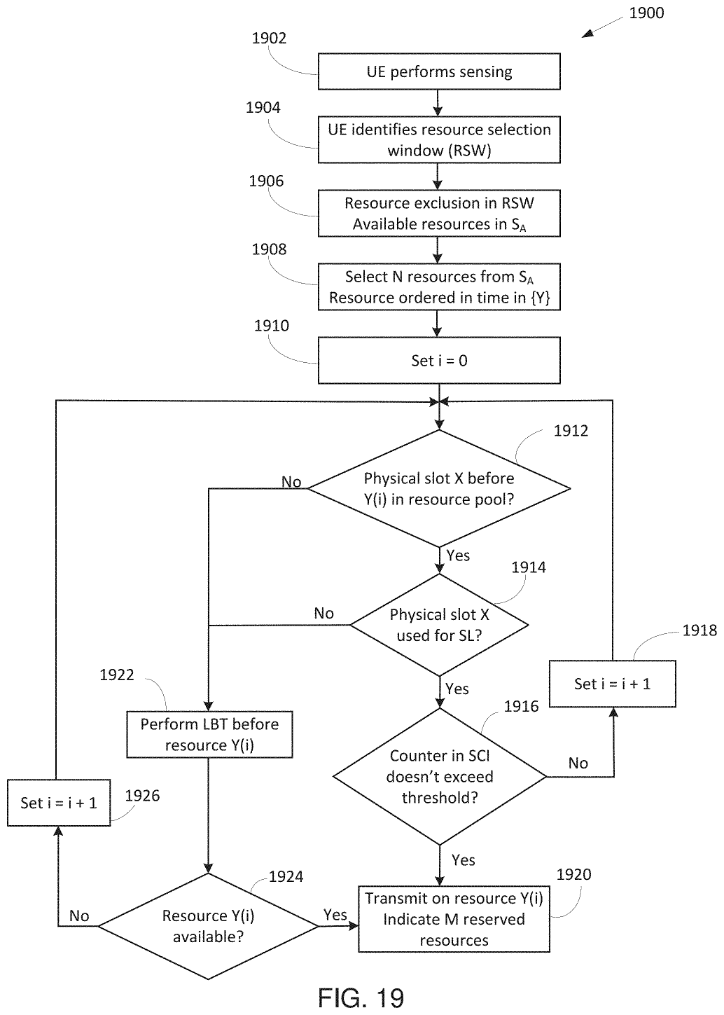

FIG. 19 illustrates yet another flowchart of UE method 1900 for combined SL sensing and LBT channel access operation according to various embodiments of the present disclosure. The UE method 1900 as may be performed by a UE (e.g., 111-116 as illustrated in FIG. 1). An embodiment of the UE method 1900 shown in FIG. 19 is for illustration only. One or more of the components illustrated in FIG. 19 can be implemented in specialized circuitry configured to perform the noted functions or one or more of the components can be implemented by one or more processors executing instructions to perform the noted functions.

As illustrated in FIG. 19, in Step 1902, a UE performs sensing. Wherein, during a sensing window, sensing involves: (1) decoding PSCCH; and (2) measuring the SL RSRP, wherein the SL RSRP can be one of; PSCCH DMRS RSRP of the decoded PSCCH, or PSSCH DMRS RSRP of the PSSCH associated with the decoded PSCCH.

In Step 1904, the UE identifies a resource selection window.

In Step 1906, the UE performs resource exclusion within a resource selection window. The resource exclusion within a resource selection window is based on: (1) reserved resources indicated by the decoded SCI, and further based on: SL RSRP associated with decoded SCI, priority associated with decoded SCI and priority associated with SL transmission; and (2) reserved resources indicated by hypothetical SCI assumed in slots not monitored during the sensing window with periodicity configured by higher layer parameter ResourceReservePeriodList-r16.

The remaining single-slot resources within the resource selection window after resource exclusion are available resources for SL transmission. Let S_{A} be the set of available resource within the resource selection window.

In Step 1908, the UE selects N single-slot resources for SL transmission from the available single-slot resources in S_{A}. The single-slot resources selected are ordered in time with index i ranging from 0 to N−1. Wherein, index i=0 corresponds to the first-in-time selected single-slot resource and index i=N−1 corresponds to the last-in-time selected single-slot resource. Let Y be the ordered set of selected single-slot resources, and i is the index of the single-slot resource within Y. In one example, the UE may perform re-evaluation check or pre-emption check, as aforementioned, before transmission in a selected resource.

FIG. 6 shows an example of the timing of the sensing window, resource selection window and a slot n, where the N single-slot resources for SL transmission are selected. Wherein, the sensing window is in the range of slots [n−T₀, n−T_{proc,0}^{SL}), and the resource selection window is in the range of slots [n−T₁, n−T₂].

In Step 1910, the UE sets i=0.

In Step 1912, the UE checks if the last physical slot (denote this as slot X) before slot associated with single-slot resource Y(i) is a slot in the resource pool. If yes proceed to step 1914. If no proceed to step 1922.

In Step 1914, the UE checks if slot X has a SL transmission and that the SL transmission in slot X extends to the end of the slot (e.g., as illustrated in the examples of FIGS. 14, 15, and 16).

In one example, the transmission in the last symbol of the last slot can be a PSSCH transmission if the slot has no PSFCH.

In another example, the transmission in the last symbol of the last slot can be a PSFCH transmission, if the slot has PSFCH.

Furthermore, the first symbol of the slot associated with single-slot resource Y(i) is a SL symbol. i.e., there is no gap (or in another example, a short gap) between the previous SL transmission and the SL transmission in single-slot resource Y(i). If all the pervious conditions of step 1914 are satisfied, proceed to step 1916, else proceed to step 1922.

In Step 1916, optionally, the UE checks a counter in the last SL transmission according to examples described herein.

In one variant: (1) if the counter does not exceed a threshold according to examples described herein; or (2) if the counter is greater than zero according to examples described herein: proceed to step 1920, else proceed to step 1918.

In a variant example of this procedure (not illustrated in FIG. 19): (1) if the counter does not exceed a threshold according to examples described herein; or (2) if the counter is greater than zero according to examples described herein: proceed to step 1920, else proceed to step 1922 (instead of step 1918).

In Step 1920, the UE transmits on the single-slot resource i, and indicates up to M reserved single-slot resource(s) for future transmissions.

In one example, a UE is (pre-)configured or updated a maximum value of Mₘₐₓ by RRC signaling and/or MAC CE signaling and/or L1 control signaling. The UE selects M such that M≤Mₘₐₓ. In one example, Mₘₐₓ=2.

In one example, a UE is (pre-)configured or updated a value M by RRC signaling and/or MAC CE signaling and/or L1 control signaling.

In one example, the M reserved resources are the M next in time resources after resource i, i.e., i+1,. . . i+M.

In one example, it is up to the UE to select the M resources. In one example, M=2.

In one example, the M reserved resources satisfy a timing requirement such that the time duration between two consecutive reserved resources is greater than or greater than or equal to Tₘᵢₙ, and the time duration between the resource i and the last indicated reserved single-slot resource is less than or less than or equal Tₘₐₓ. Wherein, Tₘᵢₙ and Tₘₐₓ can be specified in the system specifications and/or (pre-)configured or updated by RRC signaling/MAC CE signaling/L1 control signaling. Tₘᵢₙ and Tₘₐₓ can be in logical slots within the resource pool and/or in physical slots. Tₘᵢₙ or Tₘₐₓ can depend on a UE capability. Tₘᵢₙ or Tₘₐₓ can depend on the sub-carrier spacing of the SL carrier or SL BWP. Time can be in logical slots or in physical slot.

In Step 1918, the UE sets i=i+1 and go to step 1912.

In Step 1922, the UE performs LBT channel access procedure before transmission on the selected resource i.

In Step 1924, the UE checks the result of LBT channel access procedure. If resource i is available after LBT channel access procedure (i.e., LBT succeeds), go to step 1920. If resource i is not available due to LBT channel access procedure (i.e., LBT fails) in Step 1924, transmission on resource i is not performed. Set i=i+1 and go to step 1926.

In one embodiment, a SL user performs sensing and resource exclusion on the SL interface (PC5 interface).

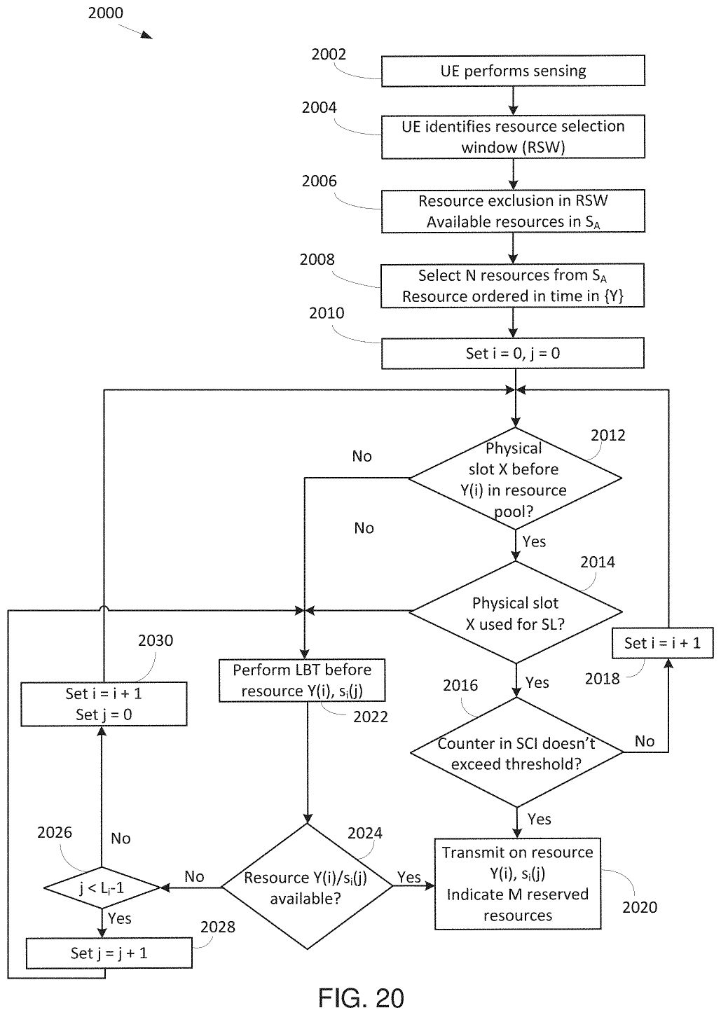

FIG. 20 illustrates yet another flowchart of UE method 2000 for combined SL sensing and LBT channel access operation according to various embodiments of the present disclosure. The UE method 2000 as may be performed by a UE (e.g., 111-116 as illustrated in FIG. 1). An embodiment of the UE method 2000 shown in FIG. 20 is for illustration only. One or more of the components illustrated in FIG. 20 can be implemented in specialized circuitry configured to perform the noted functions or one or more of the components can be implemented by one or more processors executing instructions to perform the noted functions.

As illustrated in FIG. 20, in Step 2002, a UE performs sensing. Wherein, during a sensing window, sensing involves: (1) decoding PSCCH; and (2) measuring the SL RSRP, wherein the SL RSRP can be one of; PSCCH DMRS RSRP of the decoded PSCCH, or PSSCH DMRS RSRP of the PSSCH associated with the decoded PSCCH.

In step 2004, the UE identifies a resource selection window.

In Step 2006, the UE performs resource exclusion within a resource selection window.

The resource exclusion within a resource selection window is based on: (1) reserved resources indicated by the decoded SCI, and further based on: SL RSRP associated with decoded SCI, priority associated with decoded SCI and priority associated with SL transmission; and (2) reserved resources indicated by hypothetical SCI assumed in slots not monitored during the sensing window with periodicity configured by higher layer parameter ResourceReservePeriodList-r16.

The remaining single-slot resources within the resource selection window after resource exclusion are available resources for SL transmission. Let S_{A} be the set of available resource within the resource selection window.

In Step 2008, the UE selects N single-slot resources for SL transmission from the available single-slot resources in S_{A}. The single-slot resources selected are ordered in time with index i ranging from 0 to N−1. Wherein, index i=0 corresponds to the first-in-time selected single-slot resource and index i=N−1 corresponds to the last-in-time selected single-slot resource. Let Y be the ordered set of selected single-slot resources, and i is the index of the single-slot resource within Y. In one example, the UE may perform re-evaluation check or pre-emption check, as aforementioned, before transmission in a selected resource. FIG. 6 shows an example of the timing of the sensing window, resource selection window and a slot n, where the N single-slot resources for SL transmission are selected. Wherein, the sensing window is in the range of slots [n−T₀, n−T_{proc,0}^{SL}), and the resource selection window is in the range of slots [n−T₁, n−T₂].

In single-slot resource i, a UE can start transmission at symbol sᵢ(j), wherein j=0, 1, . . . Lᵢ−1. i.e., there are multiple transmission opportunities within each single-slot resource i. If the first transmission opportunity, corresponding to j=0 in resource i fails due to LBT channel access procedure, the next transmission opportunity in resource i is LBT-checked if that succeeds the SL transmission can proceed, else the next transmission opportunity in resource i is LBT-checked, . . . and so on until the SL transmission is transmitted or there are no more available transmission opportunities in resource i, in which case the UE advances to the next resource i+1.

In one example, Lᵢ can be configured or determined separately for each single-slot resource.

In one example, if resource i includes PSFCH, L₁=L_{PSFCH}. If resource i does not include PSFCH, Lᵢ=L_{NONPSFCH}. Wherein, L_{PSFCH} and L_{NONPSFCH} are (pre-)configured and/or updated by RRC signaling/MAC CE signaling/L1 control signaling.

In another example, Lᵢ depends on a number of symbols in resource i available for PSSCH/PSCCH, wherein Lᵢ, as a function of the number of symbols, is (pre-)configured and/or updated by RRC signaling/MAC CE signaling/L1 control signaling.

In another example, Lᵢ depends on a number of symbols in resource i available for SL, wherein Lᵢ, as a function of the number of symbols, is (pre-)configured and/or updated by RRC signaling/MAC CE signaling/L1 control signaling.

In another example, Lᵢ depends on a number of symbols in resource i available for SL as well as the presence or absence of PSFCH, wherein Lᵢ, as a function of the number of symbols and presence/absence of PSFCH, is (pre-)configured and/or updated by RRC signaling/MAC CE signaling/L1 control signaling.

In one example, Lᵢ can be the same for all single-slot resources, i.e., Lᵢ=L for i=0,. . . , N−1. Wherein, L is (pre-)configured and/or updated by RRC signaling/MAC CE signaling/L1 control signaling.

In one example, sᵢ can be configured or determined separately for each SL resource. sᵢ(j) can be relative to the first symbol of resource i.

In one example, if resource i includes PSFCH, sᵢ=s_{PSFCH}. If resource i does not include PSFCH, sᵢ=s_{NONPSFCH}. Wherein, s_{PSFCH} is a set of starting symbols for a slot containing PSFCH, and s_{NONPSFCH} is a set of starting symbols for a slot not containing PSFCH. Wherein, s_{PSFCH} and s_{NONPSFCH} is (pre-)configured and/or updated by RRC signaling/MAC CE signaling/L1 control signaling.

In another example, sᵢ can depend on a number of symbols in resource i available for PSSCH/PSCCH. Wherein the set of starting symbols, sᵢ, as a function of the number of symbols, is (pre-)configured and/or updated by RRC signaling/MAC CE signaling/L1 control signaling.

In another example, sᵢ can depend on a number of symbols in resource i available for SL. Wherein the set of starting symbols, sᵢ as a function of the number of symbols, is (pre-) configured and/or updated by RRC signaling/MAC CE signaling/L1 control signaling.

In another example, sᵢ can depend on a number of symbols in resource i available for SL as well as the presence or absence of PSFCH. Wherein the set of starting symbols, sᵢ as a function of the number of symbols and presence/absence of PSFCH, is (pre-)configured and/or updated by RRC signaling/MAC CE signaling/L1 control signaling.

In one example, sᵢ can be configured or determined based on a rule.

In one example, sᵢ can be the same for all single-slot resources, i.e., sᵢ=s for i=0, . . . , N−1. Wherein, s is (pre-)configured and/or updated by RRC signaling/MAC CE signaling/L1 control signaling.

In one example, sᵢ includes the first symbol of single-slot resource i and all consecutive symbols, and such that the length of the SL transmission is at least K symbols. Wherein, K is specified in the system specifications and/or (pre-)configured and/or updated by RRC signaling/MAC CE signaling/L1 control signaling. K can be counted with or without the first duplicate symbol.

In one example, sᵢ includes the first symbol (symₛₜₐᵣₜ) and symₛₜₐᵣₜ+D, symₛₜₐᵣₜ+2D, . . . and such that the length of the SL transmission is at least K symbols. Wherein, K and D are specified in the system specifications and/or (pre-)configured and/or updated by RRC signaling/MAC CE signaling/L1 control signaling. K can be counted with or without the first duplicate symbol.

As illustrated in FIG. 20, in Step 2010, the UE sets i=0 and j=0.

In Step 2012, the UE checks if the last physical slot (denote this as slot X) before slot associated with single-slot resource Y(i) is a slot in the resource pool. If yes proceed to step 2014. If no proceed to step 2022.

In Step 2014, the UE checks if slot X has a SL transmission and that the SL transmission in slot X extends to the end of the slot (e.g., as illustrated in the examples of FIGS. 14, 15, and 16).

In one example, the transmission in the last symbol of the last slot can be a PSSCH transmission if the slot has no PSFCH.

In another example, the transmission in the last symbol of the last slot can be a PSFCH transmission, if the slot has PSFCH.

Furthermore, the first symbol of the slot associated with single-slot resource Y(i) is a SL symbol. i.e., there is no gap between the previous SL transmission and the SL transmission in single-slot resource Y(i). If all the previous conditions of step 2014 are satisfied, proceed to step 2016, else proceed to step 2018.

In Step 2016, optionally, the UE checks a counter in the last SL transmission according to examples described herein.

In one variant: (1) if the counter does not exceed a threshold according to examples described herein; Or (2) if the counter is greater than zero according to examples described herein: proceed to step 2020, else proceed to step 2016.

In a variant example of this procedure: (1) if the counter does not exceed a threshold according to examples described herein; or (2) if the counter is greater than zero according to examples described herein: proceed to step 2020, else proceed to step 2016.

In Step 2020, the UE transmits on the single-slot resource i, and indicates up to M reserved single-slot resource(s) for future transmissions.

In one example, a UE is (pre-)configured or updated a maximum value of Mₘₐₓ by RRC signaling and/or MAC CE signaling and/or L1 control signaling. The UE selects M such that M≤Mₘₐₓ. In one example, Mₘₐₓ=2.

In one example, a UE is (pre-)configured or updated a value M by RRC signaling and/or MAC CE signaling and/or L1 control signaling.

In one example, the M reserved resources are the M next in time resources after resource i, i.e., i+1,. . . i+M.

In one example, it is up to the UE to select the M resources. In one example M=2.

In one example, the M reserved resources satisfy a timing requirement such that the time duration between two consecutive reserved resources is greater than or greater than or equal to Tₘᵢₙ, and the time duration between the resource i and the last indicated reserved single-slot resource is less than or less than or equal Tₘₐₓ. Wherein, Tₘᵢₙ and Tₘₐₓ can be specified in the system specifications and/or (pre-)configured or updated by RRC signaling/MAC CE signaling/L1 control signaling. Tₘᵢₙ and Tₘₐₓ can be in logical slots within the resource pool and/or in physical slots. Tₘᵢₙ or Tₘₐₓ can depend on a UE capability. Tₘᵢₙ or Tₘₐₓ can depend on the sub-carrier spacing of the SL carrier or SL BWP. Time can be in logical slots or in physical slots.

In Step 2030, the UE sets i=i+1 and go to step 2012.

In Step 2024, the UE performs LBT channel access procedure before transmission on the selected resource i and sᵢ(j).

In Step 2024, the UE checks the result of LBT channel access procedure. If resource i starting at sᵢ(j) is available after LBT channel access procedure (i.e., LBT succeeds), go to step 2020.

In Step 2024, if resource i starting at sᵢ(j) is not available due to LBT channel access procedure (i.e., LBT fails), transmission on resource i is not performed. Check the value of j in step 2026.

In Step 2026, if j<Lᵢ−1, wherein Lᵢ are the number of starting symbols in single-slot resource i, set j=j+1 in step 2028 and go to step 2022.

In Step 2026, else, the UE sets i=i +1 in step 2030, set j=0 and go to Step 2012.

The procedural changes can be applied in various embodiments of the present disclosure. For example, the LBT channel access procedure is not applied if the last physical slot before a first SL transmission includes a second SL transmission that ends at the last symbol of that slot, and the first SL transmission starts at the first symbol of the slot and the counter of the SL transmission in the last slot does not exceed a threshold.

In a variant, the transmission in the last symbol before the guard symbol is extended, e.g., by CP extension such that the duration of the guard period is 25 μsec or 16 μsec. A UE checks if the pervious physical slot has a SL transmission that extends to the last symbol of the slot, and that the UE is transmitting on the first symbol of the slot.

If these conditions are satisfied, the UE performs a short LBT channel access procedure. If the short LBT channel access procedure succeeds the UE transmits on the SL channel. If the short LBT channel access procedure fails, the UE selects a new SL slot for SL transmission.

If the conditions are not satisfied, the UE performs normal LBT channel access procedure. The remaining details are as described herein.

In the present disclosure: (1) joint operation of SL sensing/resource exclusion and LBT channel access procedure in shared spectrum is provided; (2) a new slot structure to avoid or minimize guard symbols is provided; and (3) a SL transmission without LBT channel access procedure or with short LBT channel access procedure if pervious slot is used by a SL user is provided.

The above flowcharts and signaling flow diagrams illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
perform sensing on a sidelink (SL) interface,
determine, based on the sensing, a set of available SL resources within a SL resource pool, and
select a slot within the SL resource pool, and
a transceiver operably coupled to the processor, the transceiver is configured to perform a listen-before-talk (LBT) channel access procedure before the slot,
wherein the processor is further configured to determine a presence of available SL resources from the set of available SL resources within the slot, and
wherein the transceiver is further configured to transmit, when the LBT channel access procedure is successful and the presence is determined, in an available SL resource from the available SL resources within the slot.

2. The UE of claim 1, wherein the LBT channel access procedure is performed before the slot when the slot includes the available SL resource.

3. The UE of claim 1, wherein the processor is further configured to determine, when LBT channel access procedure is successful, the presence of the available SL resources within the slot.

4. The UE of claim 1, wherein the processor is further configured to perform, when the LBT channel access procedure fails, a random backoff and select a new slot.

5. The UE of claim 1, wherein the transceiver is further configured to perform the LBT channel access procedure in more than one symbol within the slot.

6. The UE of claim 1, wherein the transmission in the slot is extended to an end of the slot.

7. The UE of claim 1, wherein the transmission in the slot is extended to an end of the slot by repeating a last symbol of the transmission.

8. The UE of claim 1, wherein:
the slot includes a physical sidelink shared channel or physical sidelink control channel (PSSCH/PSCCH) transmission and a physical sidelink feedback channel (PSFCH) transmission, and p1 the PSSCH/PSCCH transmission extends to a start of the PSFCH transmission.

9. The UE of claim 1, wherein a guard symbol ends at time T and a last SL symbol before the guard symbol is extended to T minus G, where G is one of:
16 μs, or
25 μs.

10. The UE of claim 1, wherein:
the transceiver is further configured to:
receive a SL control information (SCI) in a logical slot X that includes a counter with a value C, and
when C is not equal to zero and the logical slot X and a logical slot X+1 are contiguous, transmit a SL transmission in logical slot X+1 after a short LBT channel access procedure, and
a counter included in the SL transmission in the logical slot X+1 has a value C−1.

11. A method of operating a user equipment (UE) in a wireless communication system, the method comprising:
performing sensing on a sidelink (SL) interface;
determining, based on the sensing, a set of available SL resources within a SL resource pool;
selecting a slot within the SL resource pool;
performing a listen-before-talk (LBT) channel access procedure before the slot;
determining a presence of available SL resources from the set of available SL resources within the slot; and
transmitting, based on the LBT channel access procedure being successful and the presence being determined, in an available SL resource from the available SL resources within the slot.

12. The method of claim 11, wherein performing LBT channel access procedure comprises performing LBT channel access procedure before the slot based on the slot including the available SL resource.

13. The method of claim 11, wherein determining the presence of the available SL resources from the set of available SL resources within the slot comprises determining, based on the LBT channel access procedure being successful, the presence of the available SL resources within the slot.

14. The method of claim 11, further comprising performing, based on the LBT channel access procedure failing, a random backoff and selecting a new slot.

15. The method of claim 11, wherein performing LBT channel access procedure comprises performing the LBT channel access procedure in more than one symbol within the slot.

16. The method of claim 11, further comprising extending the transmission in the slot to an end of the slot.

17. The method of claim 11, further comprising extending the transmission in the slot to an end of the slot by repeating a last symbol of the transmission.

18. The method of claim 11, wherein:
the slot includes a physical sidelink shared channel or physical sidelink control channel (PSSCH/PSCCH) transmission and a physical sidelink feedback channel (PSFCH) transmission, and
the method further comprises extending the PSSCH/PSCCH transmission to a start of the PSFCH transmission.

19. The method of claim 11, wherein a guard symbol ends at time T and the method further comprises:
extending a last SL symbol before the guard symbol to T minus G, where G is one of:
16 μs; or
25 μs.

20. The method of claim 11 further comprising:
receiving a SL control information (SCI) in a logical slot X that includes a counter with a value C,
transmitting, based on C is being equal to zero and the logical slot X and a logical slot X+1 being contiguous, a SL transmission in logical slot X+1 after a short LBT channel access procedure, wherein a counter with a value C−1 is included in the SL transmission in slot X+1.
